(19) United States
(12) Patent Application Publication
(10) Pub. No.: US 2025/0309814 A1
(43) Pub. Date: Oct. 2, 2025

(54) MOUNTING RAILS

(71) Applicants: ARRAY TECH, INC., Albuquerque, NM (US); Origami Solar, Inc., Sacramento, CA (US)

(72) Inventors: Benjamin C. DeFresart, Chandler, AZ (US); Thierry Marin-Martinod, Chandler, AZ (US); Nathan Schuknecht, Golden, CO (US); Kevin Krautbauer, Phoenix, AZ (US); Shuo Chen, Chandler, AZ (US); John Patton, Rocklin, CA (US); Tyler Hudson, Sacramento, CA (US); Eric Hafter, Sacramento, CA (US); Gregg Patterson, Sacramento, CA (US)

(21) Appl. No.: 19/091,712

(22) Filed: Mar. 26, 2025

Related U.S. Application Data
(60) Provisional application No. 63/570,155, filed on Mar. 26, 2024.

(51) Int. Cl. H02S 20/20; F16B 5/06

(52) U.S. Cl. CPC H02S 20/20; F16B 5/0685

(57) ABSTRACT

A mounting rail system configured to couple to a photovoltaic (PV) module is disclosed. The mounting rail system may include a mounting rail and an interlock component. The mounting rail may include an upper portion that includes a surface configured to physically engage with a bottom surface of a module frame of the PV module. The interlock component may be engaged with the mounting rail. The interlock component may include a clip. The clip and the upper portion of the mounting rail may at least partially define an aperture configured to receive a lip of the module frame during installation of the PV module to interlock the module frame with the mounting rail. The interlock component may include a separate piece of material from the mounting rail.

### CROSS-REFERENCE TO RELATED APPLICATION

This patent application claims the benefit of and priority to U.S. Provisional App. No. 63/570,155 filed Mar. 26, 2024, titled “MOUNTING RAILS,” which is incorporated in the present disclosure by reference in its entirety.

### FIELD

The embodiments discussed in the present disclosure are related to solar installations and, more particularly, to mounting rails for use in a solar installation.

### BACKGROUND

Solar installations including solar farms, photovoltaic (PV) plants, solar tracking systems, fixed solar systems, and other PV systems include large numbers of PV modules that collect sunlight and generate energy. During installation, the PV modules may be coupled to corresponding mounting rails to position the PV modules within the solar installations. In particular, the PV modules may be coupled to the corresponding mounting rails via module frames of the PV modules.

Some systems use external fasteners such as nuts, bolts, and clips to couple the module frames to the mounting rails. During installation, installers may manually pass the external fasteners through the module frames and the mounting rails on multiple sides of the module frames and then manually secure the external fasteners. The installation of the external fasteners often requires a significant amount of time. For example, four or more bolts per PV module may be manually passed through the mounting rail and the module frame and then manually secured.

Therefore, there is a need to ease the installation process of coupling the PV modules to the mounting rails.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Exemplary embodiments of the present disclosure address the problems experienced in solar installations, including problems associated with coupling the PV modules to the mounting rails. Disclosed embodiments, include mounting rails, module frames, or both that are configured to be installed using drop in techniques, slide in techniques, or both to eliminate or reduce the use of the external fasteners. In addition, the disclosed embodiments, may include clips that are configured to interface and engage with lips of module frames to couple and maintain the coupling of the mounting rails and the module frames.

Therefore, the mounting rails couple to PV modules, the lip, or other interlocking components and reduces a complexity of installing the PV modules and/or reduces an amount of time to install the PV modules. In addition, the omission of the fasteners to couple the PV modules permits the PV modules to be coupled to the mounting rails without the use of tools. Further, the omission of the fasteners to couple the PV modules reduces the cost to install the solar installations.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the accompanying drawings in which:

FIGS. 1A and 1B illustrate a perspective view and a side view, respectively, of an example embodiment of a mounting rail coupled to a PV module;

FIG. 2 illustrates a perspective view of the mounting rail of FIGS. 1A and 1B;

FIGS. 3A-3G illustrate example embodiments of mounting rails that include a deformable clip or deformable clips;

FIGS. 4A and 4B illustrate a perspective view and a side view, respectively, of an example embodiment of a mounting rail coupled to a PV module;

FIG. 5 illustrates a perspective view of the mounting rail of FIGS. 4A and 4B;

FIG. 6A illustrates an example interlock component coupled to a PV module 104;

FIG. 6B illustrates a perspective view of the example interlock component of FIG. 6;

FIGS. 7A and 7B illustrate a bottom perspective view and side view, respectively, of an example mounting rail coupled to a PV module;

FIGS. 8A and 8B illustrate a perspective view and a side view, respectively, of an example embodiment of a mounting rail coupled to a PV module;

FIG. 9 illustrates a perspective view of the mounting rail of FIGS. 8A and 8B;

FIGS. 10A and 10B illustrate example embodiments of mounting rails that include rigid clips;

FIGS. 11A and 11B illustrate a perspective view and a side view, respectively, of an example embodiment of a mounting rail that includes a deformable portion and a rigid portion;

FIG. 12 illustrates an example process diagram to couple a PV module to two instances of the mounting rail of FIGS. 11A and 11B;

FIGS. 13A-13M illustrate example embodiments of retention features that may be implemented with various embodiments disclosed in the present disclosure;

FIGS. 14A-14C illustrate example embodiments of module frames that include alignment features;

FIGS. 15A-15J illustrate example embodiments of module frames that include lips of different heights to interface with clips at different heights;

FIG. 16 illustrates an example embodiment of a module frame that includes a lip;

FIGS. 17A-17C illustrate example embodiments of module frames that include lips;

FIGS. 18A and 18B illustrate example embodiments of processes to form module frames; and

FIG. 19 illustrates a side view of an example embodiment of a mounting rail coupled to an example module frame.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise. Unless stated otherwise, directions of movement described below are relative to the corresponding figure(s).

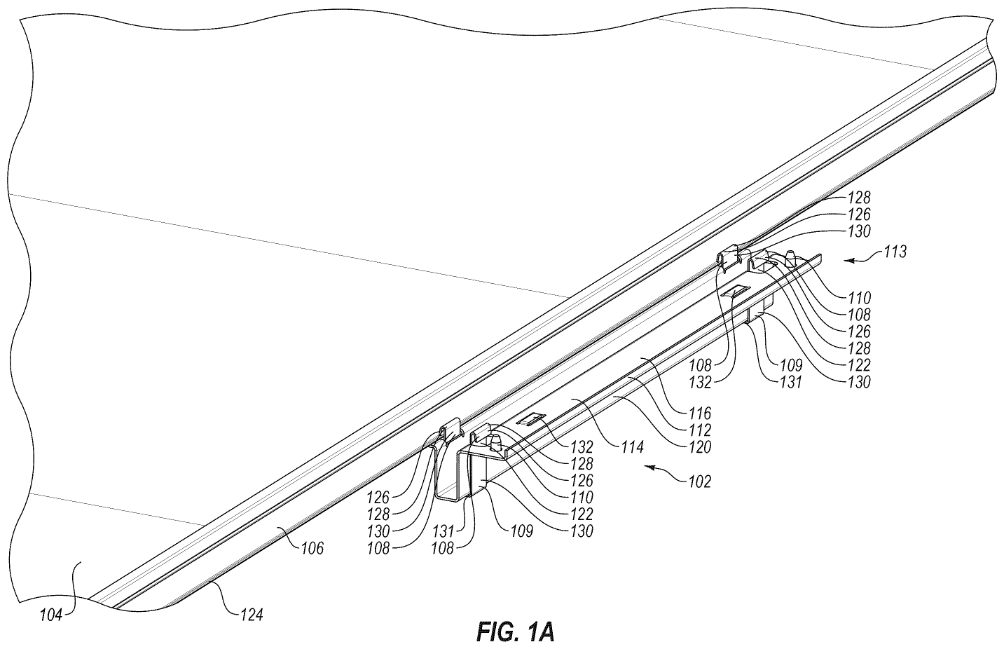

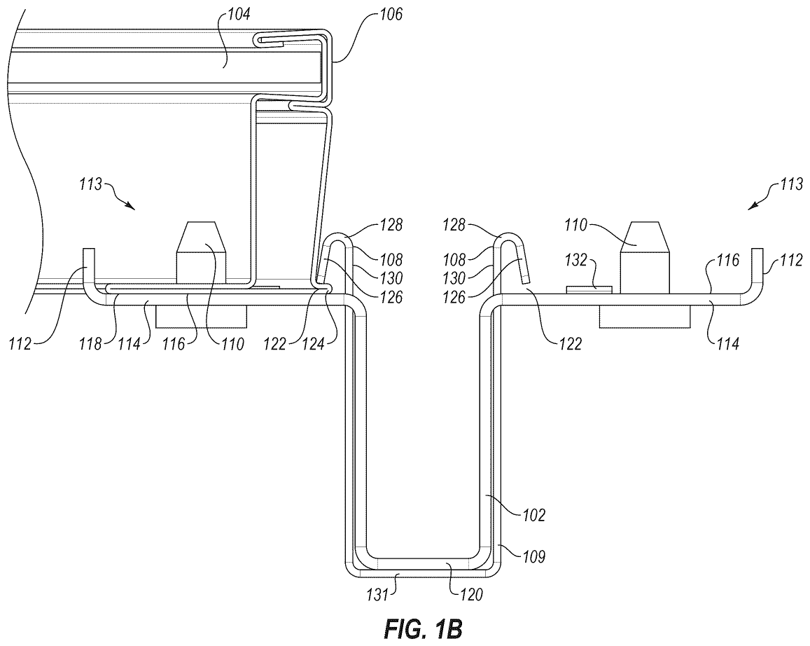

Referring to FIGS. 1A and 1B, an example of one mounting rail 102 coupled to a PV module 104 is shown. FIG. 1A illustrates a perspective view of the example mounting rail 102 coupled to the PV module 104. FIG. 1B illustrates a side view of the example mounting rail 102 coupled to the PV module 104 with a sidewall of a module frame 106 of the PV module 104 hidden.

The mounting rail 102, as discussed in more detail below, may couple to the PV module 104 via one or more interlock components 109 (generally referred to in the present disclosure as the interlock component 109), one or more location components 113 (generally referred to in the present disclosure as the location component 113) of the mounting rail 102, or some combination thereof. In some embodiments, the mounting rail 102 may be coupled to the PV module 104 using a drop in technique, in which the PV module 104 is positioned relative to the mounting rail 102 and then moved downward toward the mounting rail 102 to cause one or more components of the mounting rail 102 and/or the interlock component 109 to interface with the module frame 106.

The interlock component 109 may include a deformable clip 108 that interfaces with the module frame 106 to couple the PV module 104 to the mounting rail 102. The location component 113 may interface with the module frame 106 to position the PV module 104 relative to the mounting rail 102, prevent movement of the module frame 106 relative to the mounting rail 102, or both. As shown, the mounting rail 102 is coupled to a single instance of the PV module 104. However, the mounting rail 102 and the interlock component 109 may couple to multiple instances of the PV module 104. The mounting rail 102 and the interlock component 109 may couple the PV module 104 to a torque tube interface (not shown in FIGS. 1A and 1B) or any other appropriate solar component to position the PV module 104 within a solar installation.

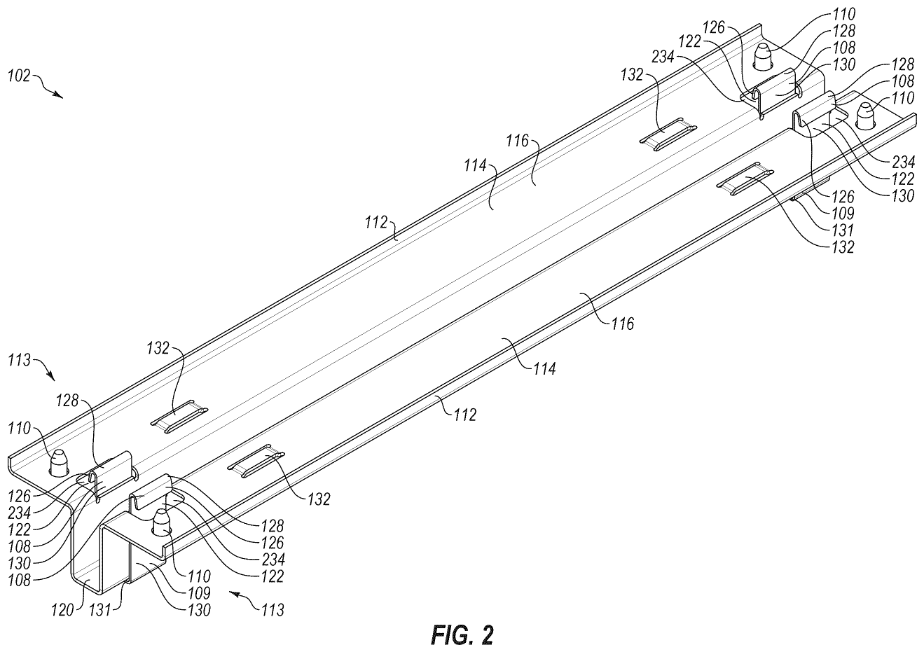

With combined reference to FIGS. 1A-2, the mounting rail 102 may include upper portions 114 (generally referred to in the present disclosure as the upper portion 114). In some embodiments, the upper portion 114 may be connected to a connection portion 120. The connection portion 120 may be shaped and sized to interface with a torque tube interface (not shown in FIGS. 1A-2) or other solar component. The upper portion 114 may include a surface 116 that physically engages with a bottom surface 118 (shown in FIG. 1B) of the module frame 106 to position the PV module 104 relative to the mounting rail 102.

The deformable clip 108 may selectively deform to permit a lip 124 of the module frame 106 to enter one or more apertures 122 (generally referred to in the present disclosure as the aperture 122) at least partially defined by the deformable clip 108 and the upper portion 114. The deformable clip 108 may include an angled portion 126 connected to a joint 128. The interlock component 109 may include an attachment portion 130 that is connected to the joint 128. In some embodiments, at least a portion of the attachment portion 130 may form part of the deformable clip 108. The attachment portion 130 may be coupled to a connection member 131 to connect neighboring attachment portions 130 to each other. The joint 128 may include a radius of curvature such that the angled portion 126 extends from the joint 128 towards the upper portion 114 when coupled to the mounting rail 102. The angled portion 126 may interface with the lip 124 during installation of the PV module 104 to cause the deformable clip 108 to selectively deform. In some embodiments, the deformable clip 108 may be elastically deformable such that during installation of the PV module 104, the deformable clip 108 moves to a deformed configuration to permit the lip 124 to be received in the aperture 122.

During installation, the PV module 104 may be positioned such that the lip 124 is proximate to the angled portion 126. The PV module 104 may be moved toward the angled portion 126 (e.g., a downward direction in FIG. 1B) to cause the lip 124 to interface with the angled portion 126. The PV module 104 may continue to be moved to cause the joint 128 to selectively deform (e.g., elastically deform). The deformable clip 108 may selectively deform and move to transition from a first position (e.g., an equilibrium position or a locked configuration as shown in FIGS. 1A-2) to a second position (e.g., a deformed configuration). In the second position, the lip 124 may move along a surface of the angled portion 126 and be received in and be at least partially disposed in the aperture 122 (each of the apertures 122 is shown in FIG. 2). In other words, the lip 124 engaging with the angled portion 126 may cause the angled portion 126 to move out of the way of the lip 124 and permit the lip 124 to be received in the aperture 122.

When the lip 124 is disposed within the aperture 122, the deformable clip 108 may return to the first position such that a portion of the lip 124 is positioned between the deformable clip 108 and the upper portion 114 to interlock the module frame 106 and the mounting rail 102. For example, the deformable clip 108 and the upper portion 114 may sandwich part of the lip 124. Alternatively, when the lip 124 is disposed within the aperture 122, the deformable clip 108 may transition to a third position (e.g., a partially returned positioned) that is between the second position and the first position such that the portion of the lip 124 is positioned between the deformable clip 108 and the upper portion 114 to interlock the module frame 106 and the mounting rail 102. In addition, when the lip 124 is received in the aperture 122, the deformable clip 108 moving from the second position to the first position or to the third position may cause the deformable clip 108 to make a sound (e.g., an audible click), which may indicate that the lip 124 is disposed within the aperture 122 and at least partially coupled to the mounting rail 102. Additionally or alternatively, the deformable clip 108 moving from the second position to the first position or to the third position may cause the deformable clip 108 to create physical feedback (e.g., haptic feedback) via the module frame 106, which may indicate that the lip 124 is disposed within the aperture 122 and at least partially coupled to the mounting rail 102. In other words, the deformable clip 108 moving from the second position to the first position or to the third position may create a sound or physical feedback to indicate that the lip 124 is in the aperture 122. For example, the deformable clip 108 moving from the second position to the first position or to the third position may cause the module frame 106 to vibrate, which an installer may detect and use to determine that the module frame 106 is installed (e.g., the lip 124 is disposed within the aperture 122 and at least partially coupled to the mounting rail 102).

The portion of the lip 124 being positioned between the deformable clip 108 and the upper portion 114 may couple the module frame 106 to the mounting rail 102. The lip 124 being at least partially disposed within the aperture 122 may prevent the module frame 106 from moving away from the surface 116 of the upper portion 114 (e.g., an upward direction in FIG. 1B). For example, the deformable clip 108 may engage with a surface of the lip 124 to maintain the engagement between the upper portion 114 and the bottom surface 118. In other words, the aperture 122 may receive the lip 124 to prevent the bottom surface 118 from unintentionally disengaging from the upper portion 114. Additionally or alternatively, the deformable clip 108 may engage with the surface of the lip 124 to prevent the lip 124 from unintentionally exiting the aperture 122 and the module frame 106 from unintentionally uncoupling with the mounting rail 102.

In some embodiments, the location component 113 may include one or more extension elements 112 (generally referred to in the present disclosure as the extension element 112) connected to the upper portion 114. In other embodiments, the extension element 112 may be omitted. The extension element 112 may interface with the module frame 106 to prevent movement of the PV module 104 along a width of the upper portion 114 (e.g., a leftward direction, a rightward direction, or both in FIG. 1B). For example, as shown in FIGS. 1A and 1B, the extension element 112 interfaces with an edge of the module frame 106 on an opposite side of the lip 124 to prevent the module frame 106 from moving away from the deformable clip 108 (e.g., the leftward direction in FIG. 1B).

The extension element 112 may prevent movement of the PV module 104 along the width of the upper portion 114 to prevent the lip 124 from unintentionally exiting the aperture 122. For example, when installed, the PV module 104 may experience a load (e.g., wind, snow, or other factors that apply a force on the PV module 104), which may try and cause the lip 124 to exit the aperture 122 and the extension element 112 may prevent this from occurring. The extension element 112 may extend from the surface 116 of the upper portion 114 at a generally perpendicular angle. In the example shown, the extension element 112 includes a flange that is connected to the upper portion 114 and extends continuously along at least part of a length of the upper portion 114. In some embodiments, the deformable clip 108 may prevent movement of the PV module along a width of the upper portion 114 (e.g., in a leftward direction in FIG. 1B).

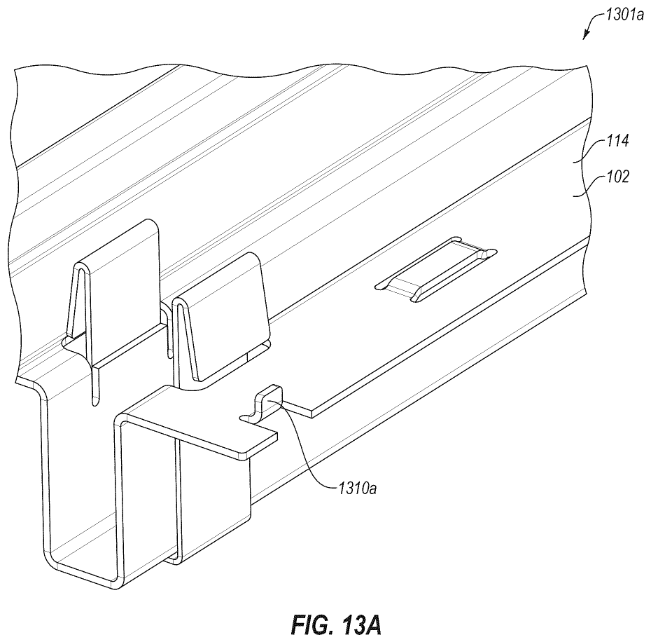

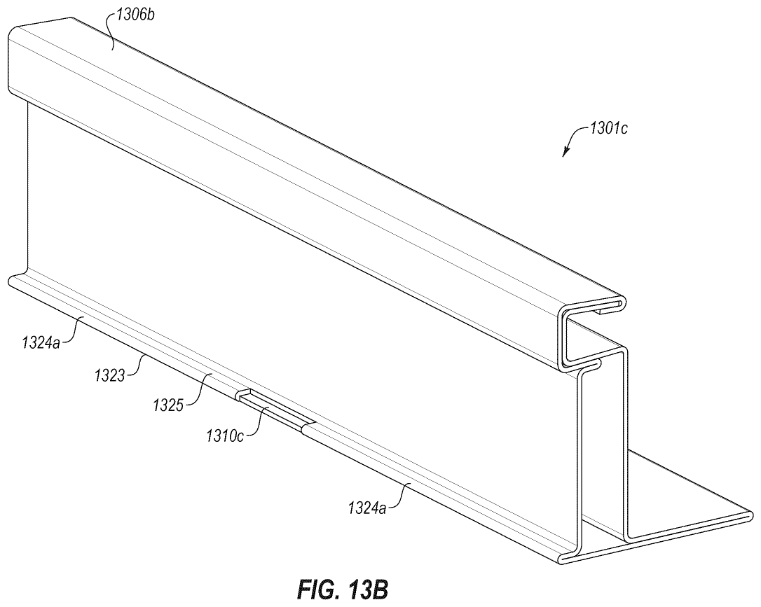

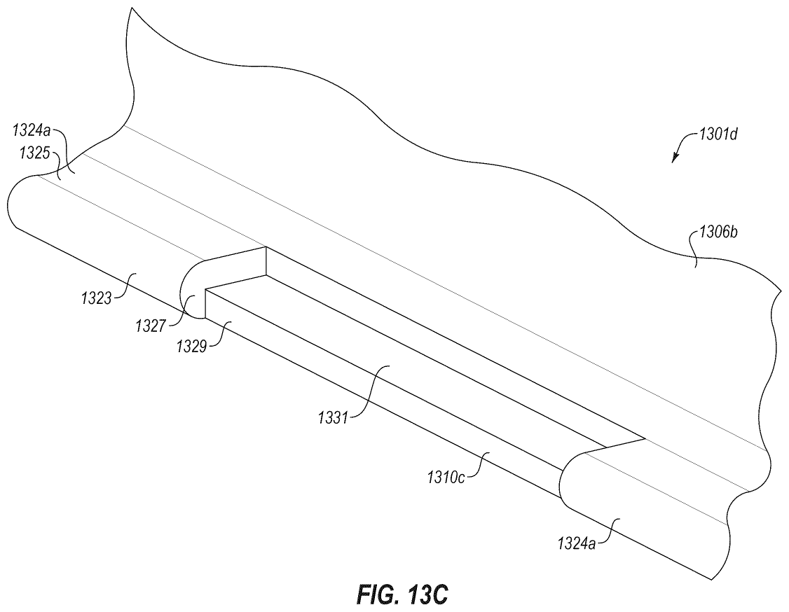

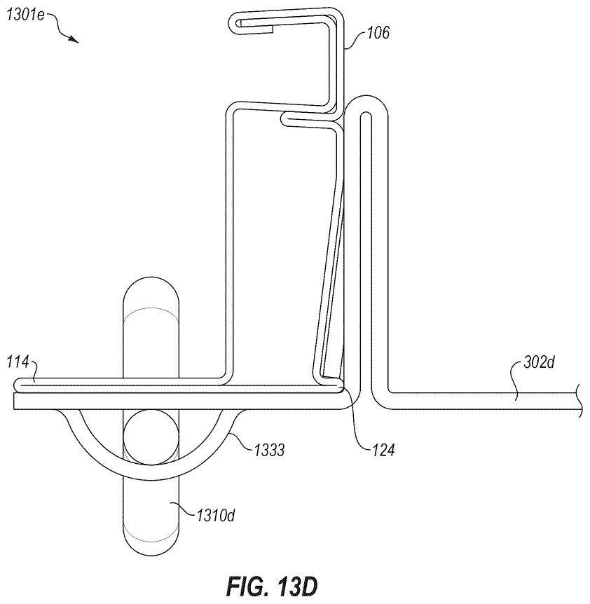

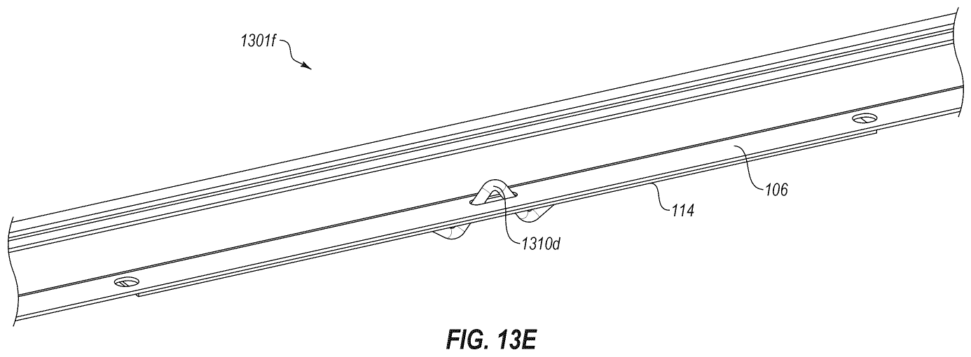

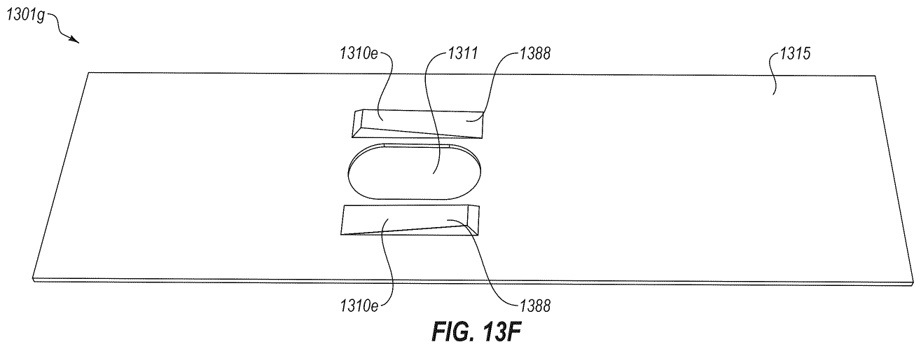

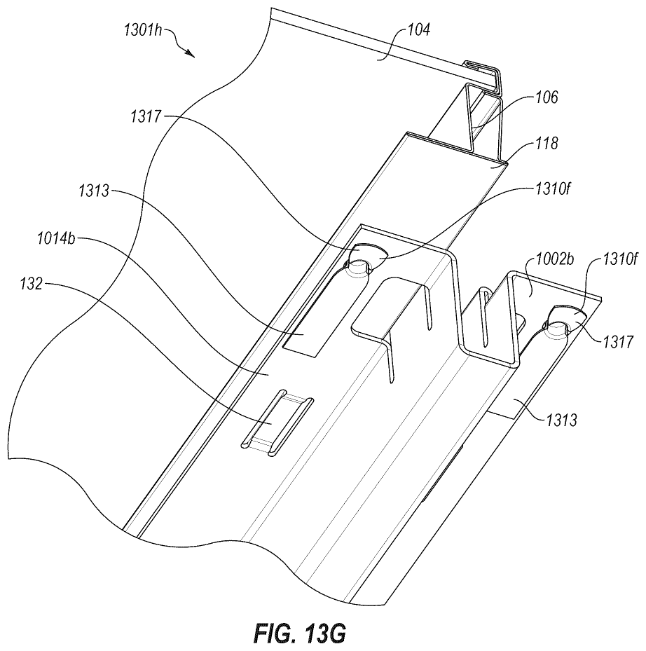

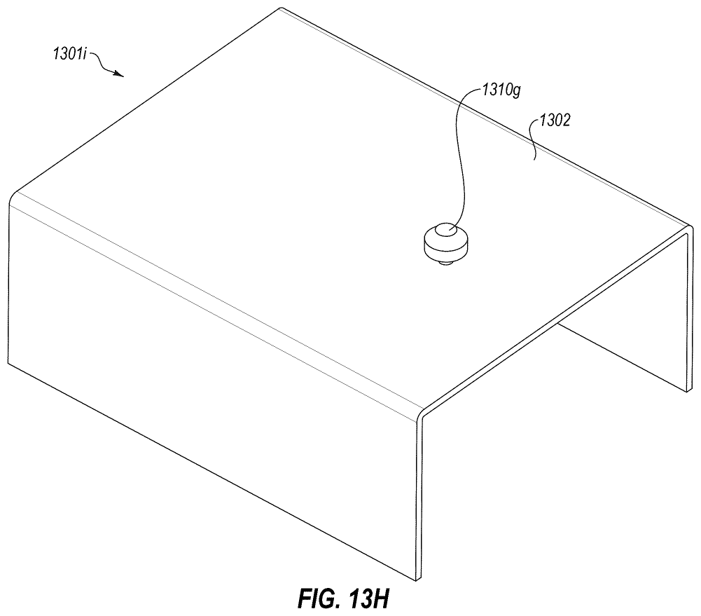

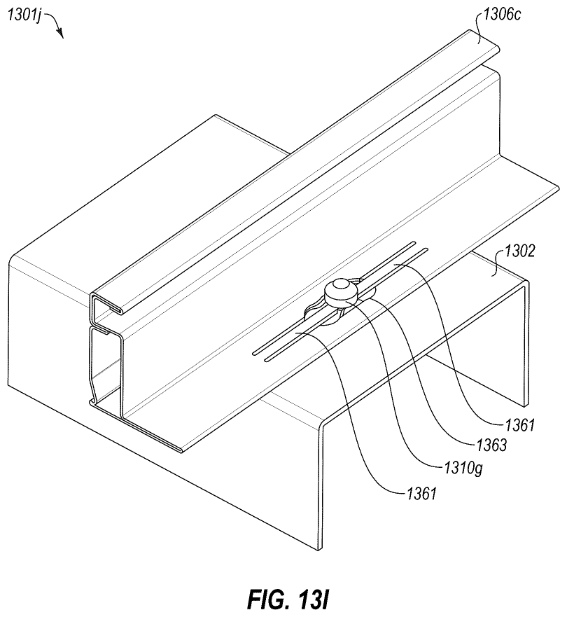

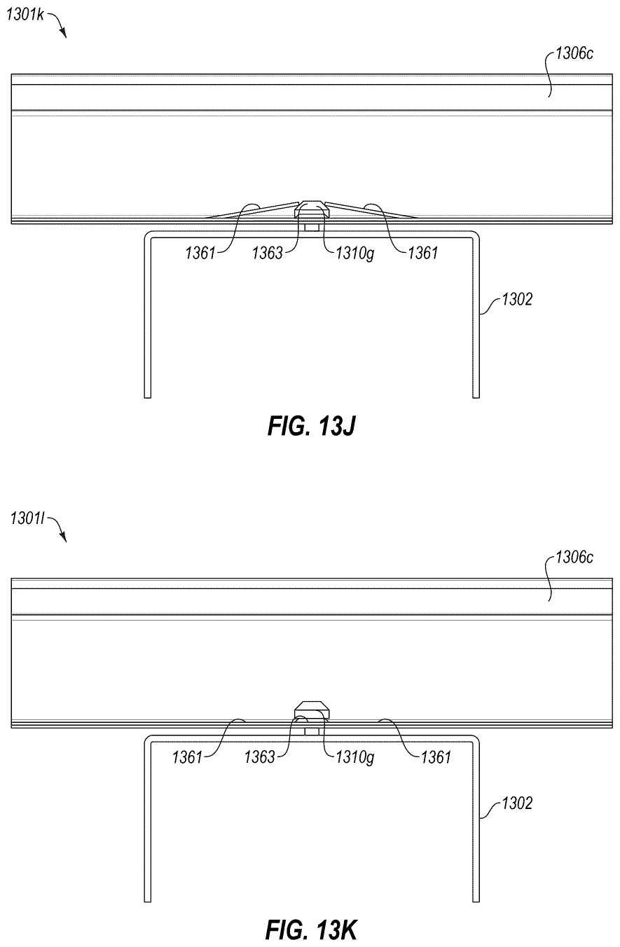

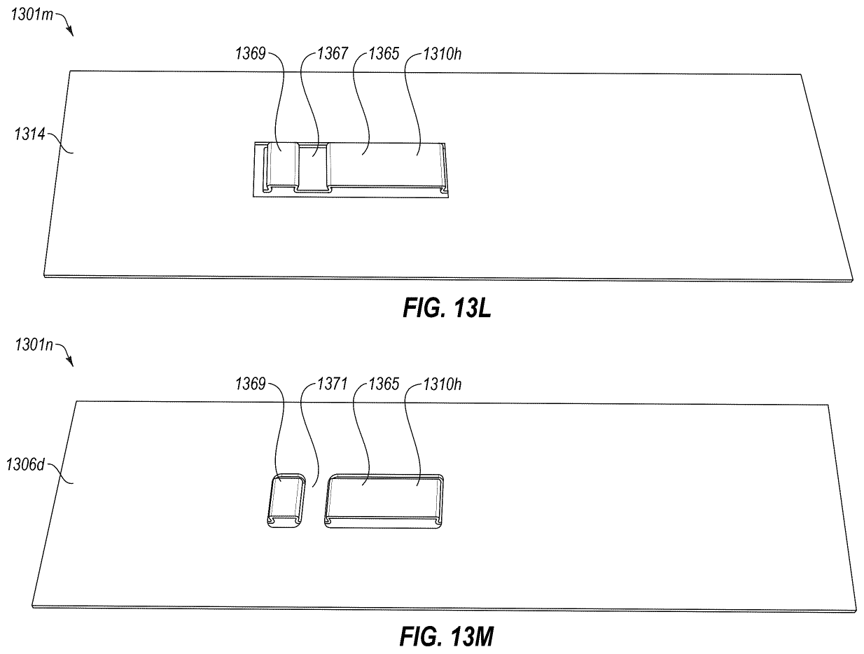

In some embodiments, the location component 113 may include one or more retention features 110 (generally referred in the present disclosure as the retention feature 110). In other embodiments, the retention feature 110 may be omitted. The retention feature 110 may facilitate a position of the PV module 104 relative to the mounting rail 102. In addition, the retention feature 110 may interface with the module frame 106 to prevent movement of the PV module 104 along the width of the upper portion 114, a length of the upper portion 114 (e.g., into or out of the page of FIG. 1B), or both. For example, the retention feature 110 may interface with openings defined by the module frame 106 to prevent movement of the module frame 106. The retention feature 110 may prevent the lip 124 from unintentionally exiting the aperture 122 (e.g., due to the load on the PV module 104 or other action). In the example shown, the retention feature 110 includes a stud connected to the upper portion 114. However, alternative embodiments of the retention feature 110 may be implemented. Example alternative embodiments of the retention feature 110 are discussed below in relation to FIGS. 13A-13M.

During installation, the PV module 104 may be positioned such that openings defined by the module frame 106 are aligned with the retention feature 110. The PV module 104 may be moved toward the upper portion 114 to cause the openings defined by the module frame 106 to receive the retention feature 110.

In some embodiments, the mounting rail 102 may include one or more bias elements 132 (generally referred to in the present disclosure as the bias element 132). Alternatively, the bias element 132 may be omitted. The bias element 132 may be connected to and extend from the upper portion 114. In addition, the bias element 132 may apply a biasing force on the module frame 106 when the lip 124 is at least partially disposed in the aperture 122. The bias element 132 may apply the biasing force in a direction that is generally perpendicular to the surface 116 of the upper portion 114. The bias element 132 may apply the biasing force to urge the lip 124 against the deformable clip 108 to enhance the interlock of the module frame 106 with the mounting rail 102.

The bias element 132 may apply the biasing force to prevent the lip 124 from moving within the aperture 122. Additionally or alternatively, the bias element 132 may apply the biasing force to prevent the module frame 106 from rattling against the mounting rail 102 (e.g., against the upper portion 114, the deformable clip 108, or both). The bias element 132 shown in FIGS. 1A-2 is a flexible spring that is punched or formed from the same material as the upper portion 114. However, alternative embodiments for the bias element 132 may include a spring, a flange, a louver, a flexible pad, a rubber pad, or any other appropriate device. Another alternative embodiment for the bias element 132 may include a curved profile of the upper portion 114. The upper portion 114 may be curved along the length of the upper portion 114 such that a middle portion of the upper portion 114 is higher than longitudinal ends of the upper portion 114 to cause the middle portion to apply the biasing force on the module frame 106. Example alternative embodiments of the bias element are described below in relation to FIGS. 13F and 13G. Alternatively, the bias element 132 may be omitted from the mounting rail 102, but the bias element 132 may be implemented on the module frame 106.

As shown in FIGS. 1A-2, the mounting rail 102 and the interlock component 109 include separate pieces of material. In some embodiments, the upper portion 114 may define one or more openings 234 configured to receive the interlock component 109. The openings 234 may receive the interlock component 109 such that at least a portion of the deformable clip 108 extends from the upper portion 114. For example, the attachment portion 130 may extend at an angle that is generally parallel to the extension element 112 and the angled portion 126 may extend from the joint 128 towards the surface 116 of the upper portion 114.

The interlock component 109 may be shaped and/or sized to interface with an exterior surface of the connection portion 120. For example, as shown in FIGS. 1A-2, the interlock component 109 includes a generally rectangular shape so as to interface with the external surface of the connection portion 120. The connection member 131, at least a portion of the attachment portion 130, or both may engage with the external surface of the connection portion 120 to prevent joints formed by the attachment portion 130 and the connection member 131 being deformed during installation of the PV module 104. The interlock component 109 may couple to the mounting rail 102 via a rivet, a press fit, a weld, a snap fit, a fastener, a fastener set that includes one or more bolt and one or more nuts, or any other appropriate manner.

The mounting rail 102 is illustrated in FIGS. 1A-2 as including four retention features 110 and the interlock components 109 are illustrated as including four deformable clips 108 for example purposes. The mounting rail 102 may include any number of retention features 110, if not omitted, such as one, two, three, or more retention features 110. In addition, the interlock components 109 may include any appropriate number of deformable clips 108 such as one, two, three, or more deformable clips 108.

In some embodiments, the deformable clip 108 may be positioned proximate to longitudinal ends of the upper portion 114. In other embodiments, the deformable clip 108 may be positioned proximate to a center of the length of the upper portion 114.

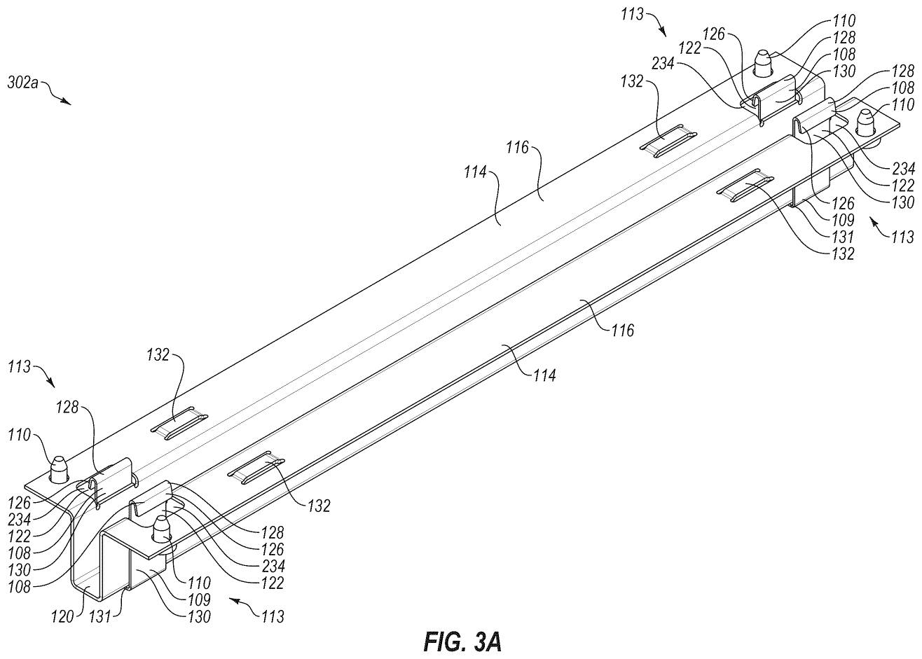

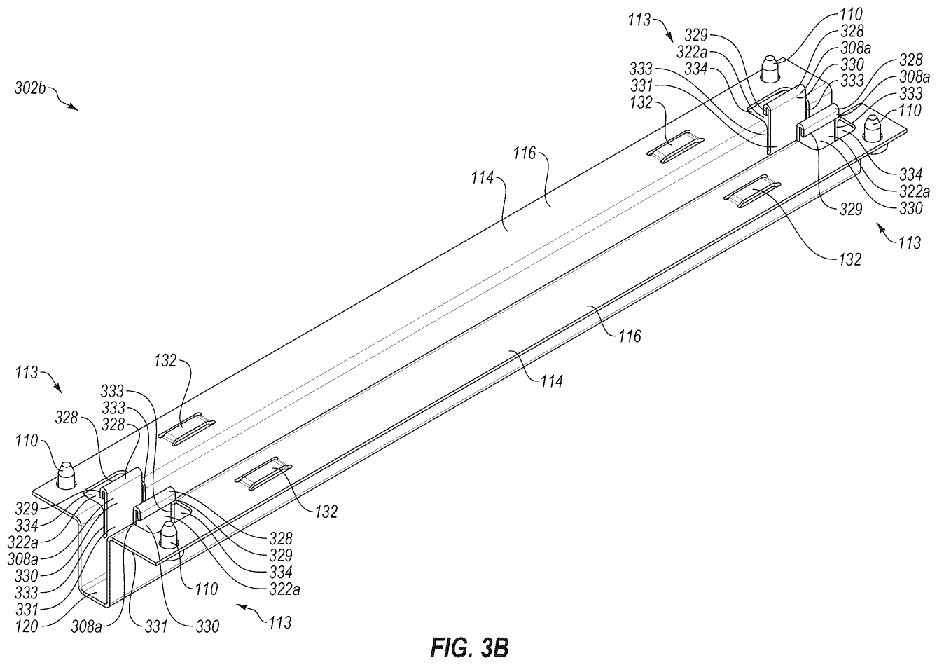

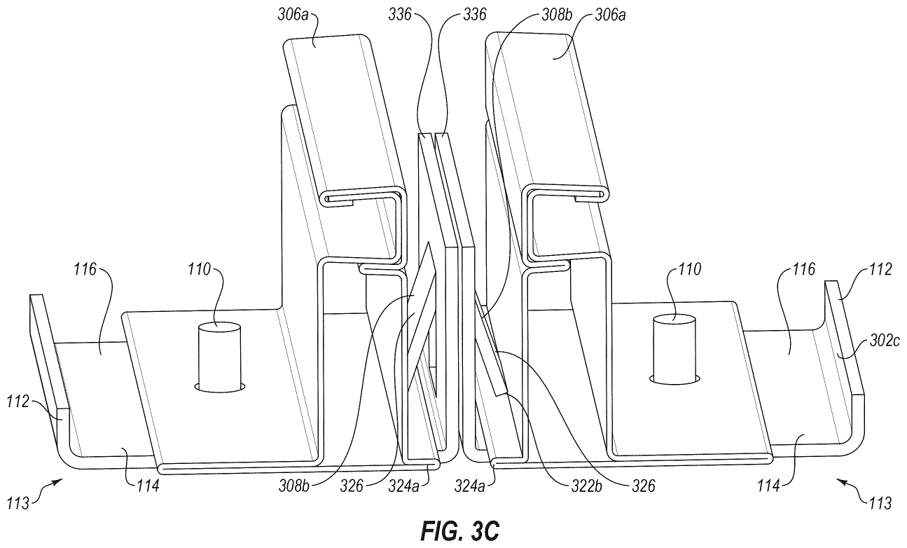

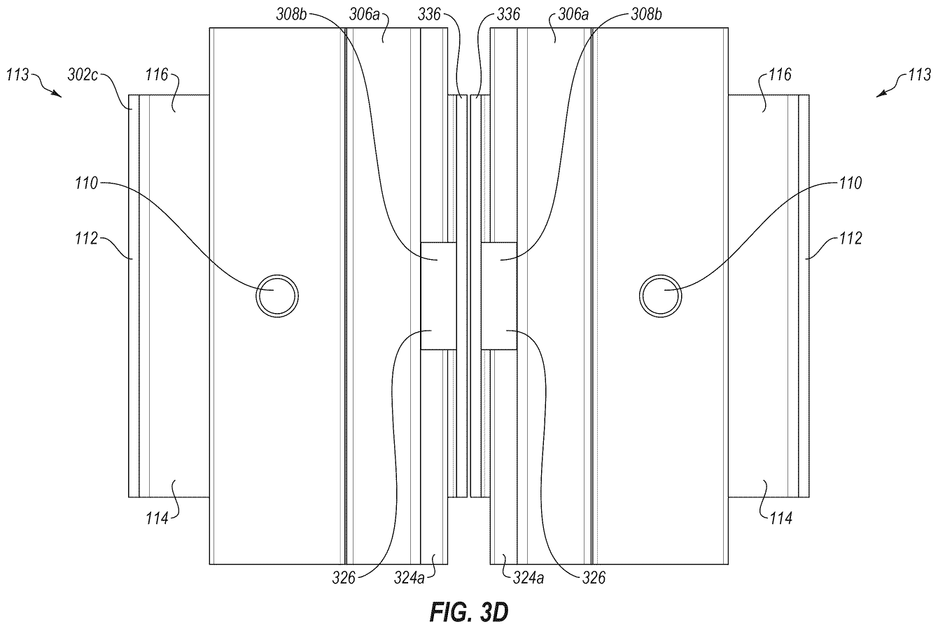

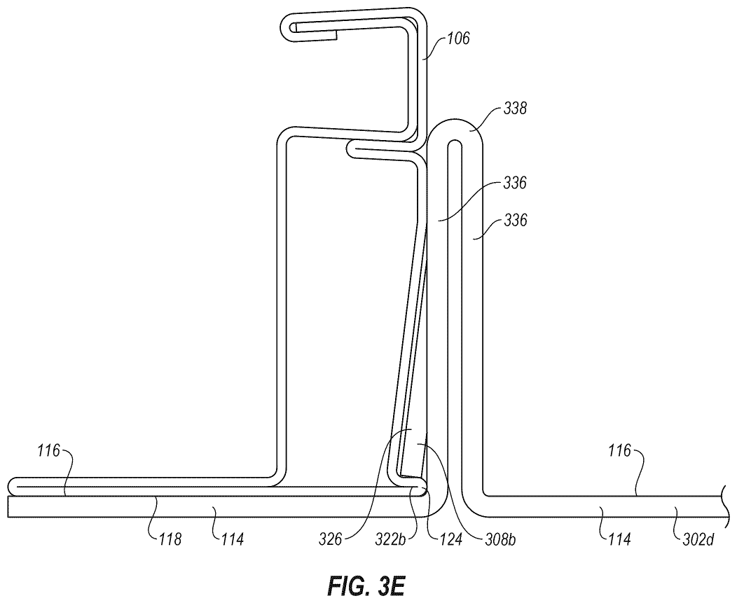

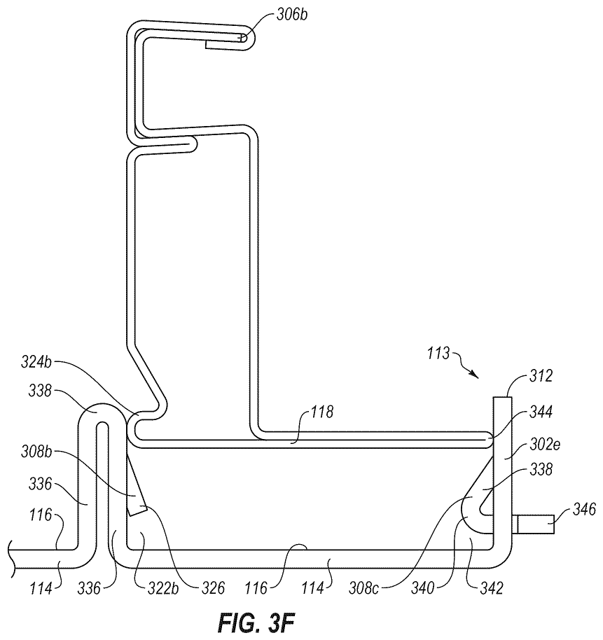

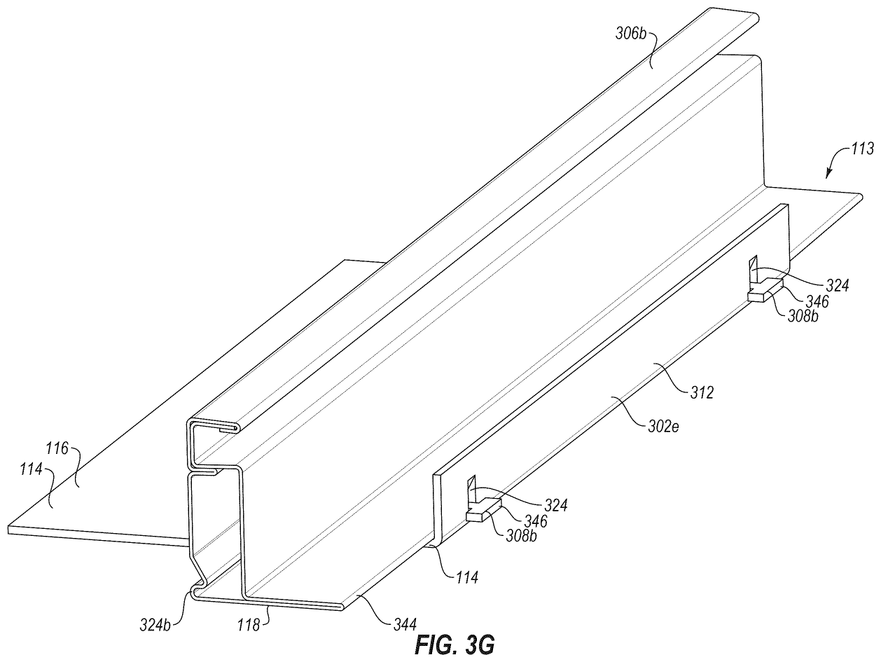

FIGS. 3A-3G illustrate additional embodiments of example mounting rails 302a-e that include the deformable clip 108 or deformable clips 108 and 308a-c. The mounting rails 302a-e may operate the same as or similar to the mounting rail 102 of FIGS. 1A-2 to couple a module frame 106, 306a, or 306b to the corresponding mounting rail 302a-e.

FIG. 3A illustrates a perspective view of the mounting rail 302a. In the example shown in FIG. 3A, the location component 113 only includes the retention feature 110. In particular, the extension element 112 is omitted. In the embodiment shown in FIG. 3A, the retention feature 110 may prevent movement of the PV module 104 relative to the mounting rail 302a.

FIG. 3B illustrates a perspective view of the mounting rail 302b. In the example shown in FIG. 3B, the location component 113 only includes the retention feature 110. In addition, in the example shown, the mounting rail 302b includes the deformable clips 308a (generally referred to in the present disclosure as deformable clip 308a). The deformable clip 308a may operate similar to the deformable clip 108 discussed above but instead of the joint 128 deforming, an attachment portion 330 may deform.

The attachment portion 330 may selectively deform to permit the lip 124 of the module frame 106 to enter one or more apertures 322a at least partially defined by the deformable clip 308a. The deformable clip 308a may include a rigid portion 329 connected to the attachment portion 330 to form a joint 328. In some embodiments, the deformable clip 308a may be punched or otherwise formed from the same piece of material as the upper portion 114 and/or the connection portion 120. The rigid portion 329 may interface with the lip 124 to cause the attachment portion 330 to selectively deform along or relative to a deformable end 331. In some embodiments, the deformable end 331 may be formed where the attachment portion 330 and the connection portion 120 are connected to each other. Additionally or alternatively, the deformable end 331 may selectively deform due to a depth of relief openings 333 extending from the upper portion 114 along a portion of the connection portion 120.

In addition, the mounting rail 302b includes a unitary piece of material. In particular, the upper portion 114, the connection portion 120, the bias element 132, and the deformable clip 108 are all integrally formed from the unitary piece of material. The upper portion 114 may define one or more openings 334 proximate to the deformable clip 108. The openings 334 may be formed when the deformable clip 108 is punched or otherwise formed from the unitary piece of material.

FIG. 3C illustrates a perspective view of sections of the mounting rail 302c coupled to sections of two instances of the module frame 306a. FIG. 3D illustrates a top view of the sections of the mounting rail 302c coupled to the section of the two instances of the module frame 306a. The mounting rail 302c may include one or more deformable clips 308b (generally referred to in the present disclosure as the deformable clip 308b). The deformable clip 308b may operate the same as or similar to the deformable clip 108 discussed above but in regard to the module frame 306a. Alternatively, the mounting rail 302c may be implemented using the module frame 106 described above.

The deformable clip 308b may selectively deform to permit the lip 124 of the module frame 306a to enter one or more apertures 322b at least partially defined by the deformable clip 308b and the upper portion 114. The deformable clip 308b may include an angled portion 326 connected to a sidewall 336 of the upper portion 114. In some embodiments, the angled portion 326 may be punched or otherwise formed from the same piece of material as the sidewall 336 to form a joint that includes a radius of curvature. The angled portion 326 may interface with the lip 124 to cause the deformable clip 308b to selectively deform. In some embodiments, the deformable clip 308b may be elastically deformable such that during installation of the module frame 306a, the deformable clip 308b moves to a deformed configuration to permit the lip 124 to be received in the aperture 322b.

During installation, the module frame 306a may be positioned such that a lip 324a is proximate to the angled portion 326. The module frame 306a may be moved toward the angled portion 326 to cause the lip 324a to interface with the angled portion 326. The module frame 306a may continue to be moved to cause the joint formed by the sidewall 336 and the angled portion 326 to selectively deform (e.g., elastically deform). The deformable clip 308b may selectively deform and move to transition from a first position (e.g., an equilibrium position or a locked configuration as shown in FIG. 3C) to a second position (e.g., a deformed configuration). In the second position, the lip 324a may move along a surface of the angled portion 326 and be received in and be at least partially disposed in the aperture 322b. In other words, the lip 324a engaging with the angled portion 326 may cause the angled portion 326 to move out of the way of the lip 324a and permit the lip 324a to be received in the aperture 322b.

When the lip 324a is disposed within the aperture 322b, the deformable clip 308b may return to the first position such that a portion of the lip 324a is positioned between the deformable clip 308b and the upper portion 114 to interlock the module frame 306a and the mounting rail 302c. Alternatively, when the lip 324a is disposed within the aperture 322b, the deformable clip 308b may transition to a third position (e.g., a partially returned positioned) that is between the second position and the first position such that the portion of the lip 324a is positioned between the deformable clip 308b and the upper portion 114 to interlock the module frame 306a and the mounting rail 302c. In addition, when the lip 324a is received in the aperture 322b, the deformable clip 308b moving from the second position to the first position or to the third position may cause the deformable clip 308b to make a sound (e.g., an audible click), which may indicate that the lip 324a is disposed within the aperture 322b and at least partially coupled to the mounting rail 302c. Additionally or alternatively, the deformable clip 308b moving from the second position to the first position or to the third position may cause the deformable clip 308b to create physical feedback (e.g., haptic feedback) via the module frame 306a, which may indicate that the lip 324a is disposed within the aperture 322b and at least partially coupled to the mounting rail 302c. In other words, the deformable clip 308b moving from the second position to the first position or to the third position may create a sound or physical feedback to indicate that the lip 324a is in the aperture 322b. For example, the deformable clip 308b moving from the second position to the first position or to the third position may cause the module frame 306a to vibrate, which an installer may detect and use to determine that the lip 324a is disposed within the aperture 322b and at least partially coupled to the mounting rail 302c. The sidewall 336 may extend along at least a portion of a length of the mounting rail 302c.

FIG. 3E illustrates a side view of the mounting rail 302d. In the example shown in FIG. 3E, the location component 113 is omitted. In addition, in the example shown in FIG. 3E, the deformable clip 308b extends from a single instance of the sidewall 336. Alternatively, the deformable clip 308b may extend from multiple instances of the sidewall 336 (e.g., on both sides of the mounting rail 302d). Further, the instances of the sidewall 336 are connected to each other to form a joint 338 such that the mounting rail 302d may be formed from a unitary piece of material.

FIG. 3F illustrates a side view of the mounting rail 302e coupled to the module frame 306b. FIG. 3G illustrates a perspective view of the mounting rail 302e coupled to the module frame 306b. In the example shown in FIG. 3F, the location component 113 includes an extension element 312. The mounting rail 302e may include the deformable clip 308b and a secondary deformable clip 308c. The secondary deformable clip 308c may operate the same as or similar to the deformable clip 308b but may engage with an edge of a return flange 344 instead of a lip 324b of the module frame 306b. The mounting rail 302e may include the secondary deformable clip 308c to enhance the interlock of the module frame 306b and the mounting rail 302e.

The secondary deformable clip 308c may selectively deform to permit the edge of the return flange 344 to enter one or more apertures 342 at least partially defined by the secondary deformable clip 308c and the upper portion 114. The secondary deformable clip 308c may include an angled portion 326 connected to an extension element 312 of the mounting rail 302e. In some embodiments, the angled portion 326 may be punched or otherwise formed from the same piece of material as the extension element 312 to form a joint that includes a radius of curvature. The angled portion 326 may interface with the edge of the return flange 344 to cause the secondary deformable clip 308c to selectively deform. In some embodiments, the secondary deformable clip 308c may be elastically deformable such that during installation of the module frame 306b, the secondary deformable clip 308c moves to a deformed configuration to permit the edge of the return flange 344 to be received in the aperture 342.

During installation, the module frame 306b may be positioned such that the edge of the return flange 344 is proximate to the angled portion 326. The module frame 306b may be moved toward the angled portion 326 to cause the edge of the return flange 344 to interface with the angled portion 326. The module frame 306b may continue to be moved to cause the joint formed by the extension element 312 and the angled portion 326 to selectively deform (e.g., elastically deform). The secondary deformable clip 308c may selectively deform and move to transition from a first position (e.g., an equilibrium position or a locked configuration as shown in FIG. 3F) to a second position (e.g., a deformed configuration). In the second position, the edge of the return flange 344 may move along a surface of the angled portion 326 and be received in and be at least partially disposed in the aperture 342. In other words, the edge of the return flange 344 engaging with the angled portion 326 may cause the angled portion 326 to move out of the way of the edge of the return flange 344 and permit the edge of the return flange 344 to be received in the aperture 342.

When the edge of the return flange 344 is disposed within the aperture 342, the secondary deformable clip 308c may return to the first position such that a portion of the edge of the return flange 344 is positioned between the secondary deformable clip 308c and the upper portion 114 to interlock the module frame 306b and the mounting rail 302e. Alternatively, when the edge of the return flange 344 is disposed within the aperture 342, the secondary deformable clip 308c may transition to a third position (e.g., a partially returned positioned) that is between the second position and the first position such that the edge of the return flange 344 is positioned between the secondary deformable clip 308c and the upper portion 114 to interlock the module frame 306b and the mounting rail 302e. In addition, when the edge of the return flange 344 is received in the aperture 342, the secondary deformable clip 308c moving from the second position to the first position or to the third position may cause the secondary deformable clip 308c to make a sound (e.g., an audible click), which may indicate that the edge of the return flange 344 is disposed within the aperture 342 and at least partially coupled to the mounting rail 302e. Additionally or alternatively, the secondary deformable clip 308c moving from the second position to the first position or to the third position may cause the secondary deformable clip 308c to create physical feedback (e.g., haptic feedback) via the module frame 306b, which may indicate that the edge of the return flange 344 is disposed within the aperture 342 and at least partially coupled to the mounting rail 302e. In other words, the secondary deformable clip 308c moving from the second position to the first position or to the third position may create a sound or physical feedback to indicate that the edge of the return flange 344 is in the aperture 342. For example, the secondary deformable clip 308c moving from the second position to the first position or to the third position may cause the module frame 306b to vibrate, which an installer may detect and use to determine that the edge of the return flange 344 is disposed within the aperture 342 and at least partially coupled to the mounting rail 302e.

In some embodiments, the secondary deformable clip 308c may include an appendage portion 346 connected to the angled portion 326 to form a joint 340. The appendage portion 346 may extend through an opening 324 defined by the extension element 312. The appendage portion 346 may include a wider portion that acts as a stop to prevent at least a portion of the appendage portion 346 from passing through the opening 324 when the secondary deformable clip 308c returns to or is in the second position.

In some embodiments, the location component 113 may include the extension element 312 connected to the upper portion 114. The extension element 312 may interface with the edge of the return flange 344 to prevent movement of the module frame 306b along a width of the upper portion 114 (e.g., a leftward direction, a rightward direction, or both in the side view in FIG. 3F). The extension element 312 may operate the same as or similar to the extension element 112 discussed above.

With combined reference to FIGS. 3C-3G, the mounting rails 302c-e may include the bias element 132, the retention feature 110 (as shown in FIG. 3C), or both. Alternatively, the bias element 132, the retention feature 110, or both may be omitted.

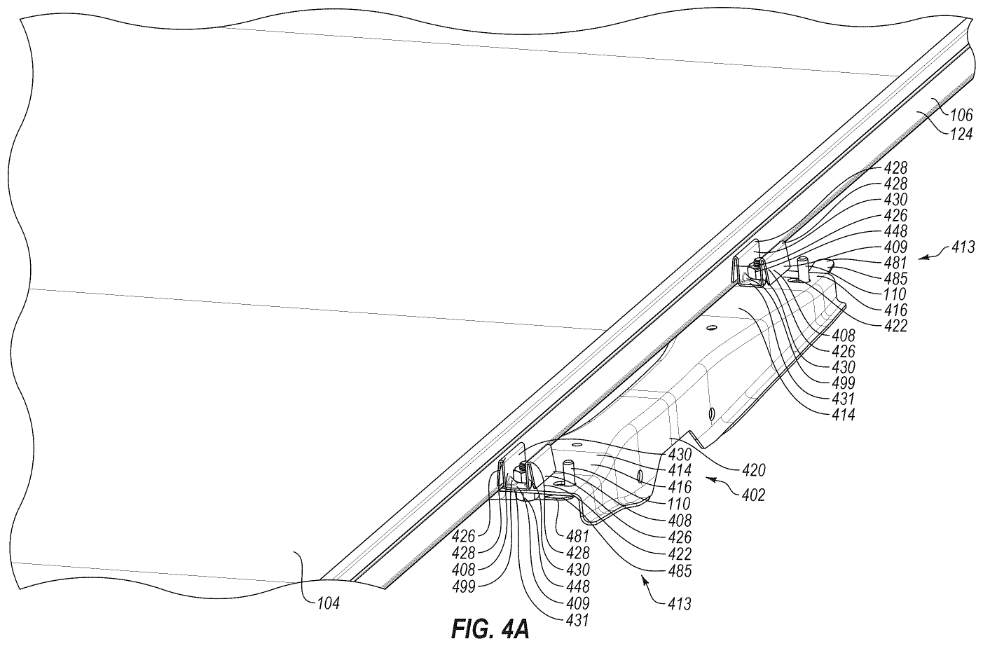

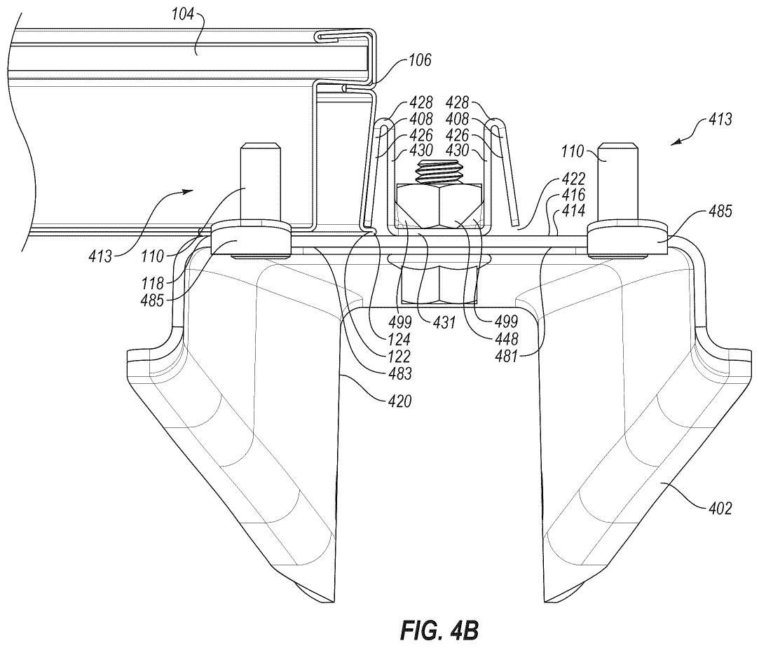

Referring to FIGS. 4A and 4B, an example of one mounting rail 402 coupled to the PV module 104 is shown. FIG. 4A illustrates a perspective view of the example mounting rail 402 coupled to the PV module 104. FIG. 4B illustrates a side view of the example mounting rail 402 coupled to the PV module 104 with a sidewall of the module frame 106 hidden.

The mounting rail 402, as discussed in more detail below, may couple to the PV module 104 via one or more interlock components 409 (generally referred to in the present disclosure as the interlock component 409), one or more location components 413 (generally referred to in the present disclosure as the location component 413), or some combination thereof. The interlock component 409 may include a deformable clip 408 that interfaces with the module frame 106 to couple the PV module 104 to the mounting rail 402. As shown in FIGS. 4A and 4B, the mounting rail 402 is coupled to a single instance of the PV module 104. However, the mounting rail 402 and the interlock component 409 may couple to multiple instances of the PV module 104. The mounting rail 402 and the interlock component 409 may couple the PV module 104 to a torque tube interface (not shown in FIG. 1) or any other appropriate solar component.

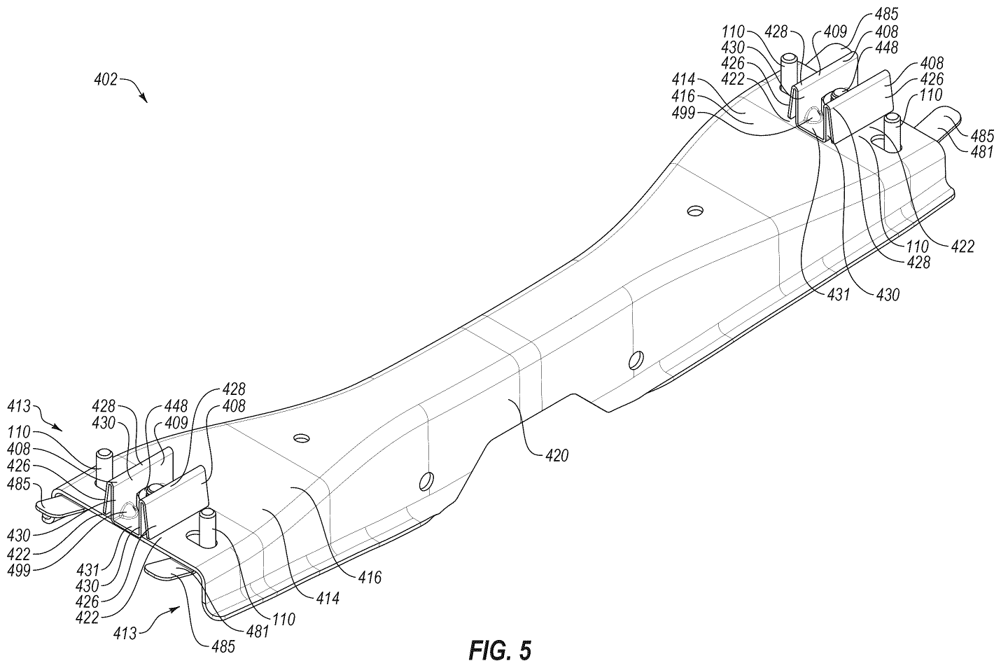

With combined reference to FIGS. 4A-5, the mounting rail 402 may include upper portions 414 (generally referred to in the present disclosure as the upper portion 414). In some embodiments, the upper portion 414 may be connected to a connection portion 420. The connection portion 420 may be shaped and sized to interface with a torque tube (not shown in FIGS. 4A-5) or other solar component. The upper portion 414 may include a surface 416 that physically engages with the bottom surface 118 of the module frame 106 to position the PV module 104 relative to the mounting rail 402.

The interlock component 409 may include a connection member 431 that includes a surface that engages with the surface 416 of the upper portion 414. The deformable clip 408 may be connected on opposite sides of the connection member 431.

The deformable clip 408 may selectively deform to permit the lip 124 to enter one or more apertures 422 (generally referred to in the present disclosure as the aperture 422) at least partially defined by the deformable clip 408 and the upper portion 414. The deformable clip 408 may include an angled portion 426 connected to a joint 428. The interlock component 409 may include an attachment portion 430 that is connected to the joint 428. In some embodiments, at least a portion of the attachment portion 430 may form part of the deformable clip 408. The attachment portion 430 may be coupled to a connection member 431 to connect neighboring attachment portions 430 to each other. The joint 428 may include a radius of curvature such that the angled portion 426 extends from the joint 428 towards the upper portion 414 when coupled to the mounting rail 402. The angled portion 426 may interface with the lip 124 during installation of the PV module 104 to cause the deformable clip 408 to selectively deform. In some embodiments, the deformable clip 408 may be elastically deformable such that during installation of the PV module 104, the deformable clip 408 moves to a deformed configuration to permit the lip 124 to be received in the aperture 422.

The interlock component 409 may include one or more gussets 499 that are connected to the connection member 431 and the attachment portion 430. The gussets 499 may be configured to support portions of the interlock component 409, prevent portions of the interlock component 409 from deforming, or both. For example, the gussets 499 may support the attachment portion 430, a connection between the connection member 431 and the attachment portion 430, or both. As another example, the gussets 499 may prevent joints between the attachment portion 430 and the connection member 431 from bending during installation of the module frame 106. The gussets 499 may include additional material added to the interlock component 409, an indentation in the interlock component 409, or any other appropriate bracket to strengthen an angle of the interlock component 409.

During installation, the PV module 104 may be positioned such that the lip 124 is proximate to the angled portion 426. The PV module 104 may be moved toward the angled portion 426 (e.g., a downward direction in FIG. 4B) to cause the lip 124 to interface with the angled portion 426. The PV module 104 may continue to be moved to cause the joint 428, a joint formed by the attachment portion 430, or both to selectively deform (e.g., elastically deform). The deformable clip 408 may selectively deform and move to transition from a first position (e.g., an equilibrium position or a locked configuration as shown in FIGS. 4A-5) to a second position (e.g., a deformed configuration). In the second position, the lip 124 may move along a surface of the angled portion 426 and be received in and be at least partially disposed in the aperture 422 (each of the apertures 422 is shown in FIG. 5). In other words, the lip 124 engaging with the angled portion 426 may cause the angled portion 426 to move out of the way of the lip 124 and permit the lip 124 to be received in the aperture 422.

When the lip 124 is disposed within the aperture 422, the deformable clip 408 may return to the first position such that a portion of the lip 124 is positioned between the deformable clip 408 and the upper portion 414 to interlock the module frame 106 and the mounting rail 402. For example, the deformable clip 408 and the upper portion 414 may sandwich part of the lip 124. Alternatively, when the lip 124 is disposed within the aperture 422, the deformable clip 408 may transition to a third position (e.g., a partially returned positioned) that is between the second position and the first position such that the lip 124 is positioned between the deformable clip 408 and the upper portion 414 to interlock the module frame 106 and the mounting rail 402. In addition, when the lip 124 is received in the aperture 422, the deformable clip 408 moving from the second position to the first position or to the third position may cause the deformable clip 408 to make a sound (e.g., an audible click), which may indicate that the lip 124 is disposed within the aperture 422 and at least partially coupled to the mounting rail 402. The portion of the lip 124 being positioned between the deformable clip 408 and the upper portion 414 may couple the module frame 106 to the mounting rail 402. Additionally or alternatively, the deformable clip 408 moving from the second position to the first position or to the third position may cause the deformable clip 408 to create physical feedback (e.g., haptic feedback) via the module frame 106, which may indicate that the lip 124 is disposed within the aperture 422 and at least partially coupled to the mounting rail 402. In other words, the deformable clip 408 moving from the second position to the first position or to the third position may create a sound or physical feedback to indicate that the lip 124 is in the aperture 422. For example, the deformable clip 408 moving from the second position to the first position or to the third position may cause the module frame 106 to vibrate, which an installer may detect and use to determine that the module frame 106 is installed (e.g., the lip 124 is disposed within the aperture 422 and at least partially coupled to the mounting rail 402).

The portion of the lip 124 being positioned between the deformable clip 408 and the upper portion 414 may couple the module frame 106 to the mounting rail 402. The lip 124 being at least partially disposed within the aperture 422 may prevent the module frame 106 from moving away from the surface 416 of the upper portion 414 (e.g., an upward direction in FIG. 4B). For example, the deformable clip 408 may engage with a surface of the lip 124 to maintain the engagement between the upper portion 414 and the bottom surface 118. In other words, the aperture 422 may receive the lip 124 to prevent the bottom surface 118 from unintentionally disengaging from the upper portion 414. Additionally or alternatively, the deformable clip 408 may engage with the surface of the lip 124 to prevent the lip 124 from unintentionally exiting the aperture 422.

The interlock component 409 may be shaped and/or sized to interface with the upper portion 114. The interlock component 409 may be configured to be positioned on the surface 416 of the upper portion 114 to permit the interlock component 409 to interface with the module frame 106. The interlock component 409 may be coupled to the mounting rail 402. For example, as shown in FIGS. 4A-5, the interlock component 409 is coupled to the upper portion 414 via a fastener 448. The interlock component 409 may couple to the upper portion 414 via any appropriate manner. For example, the interlock component 409 may couple to the mounting rail 402 via a rivet, a press fit, a weld, a snap fit, a fastener set that includes one or more bolts and one or more nuts, or any other appropriate manner. The fastener 448 as shown includes a nut which may be configured to support portions of the interlock component 409, prevent portion of the interlock component 409 from deforming, or both. For example, the nut of the fastener 448 may support the attachment portion 430, the connection between the connection member 431 and the attachment portion 430, or both. As another example, the nut of the fastener 448 may prevent the joint between the attachment portion 430 and the connection member 431 from bending during installation of the module frame 106.

In some embodiments, the mounting rail 402 may include a retention component 481 that includes the retention feature 110. In other embodiments, the retention component 481 may be omitted. The retention component 481 may include a connection member 483 (shown in FIG. 4B) coupled to the retention feature 110. Additionally or alternatively, the connection member 483 may be coupled to lifting springs 485 (generally referred to in the present disclosure as the lifting spring 485).

The retention component 481 shown in FIGS. 4A-5 includes a unitary piece of material. In particular, the retention feature 110, the connection member 483, and the lifting spring 485 are all integrally formed from the unitary piece of material. However, the retention component 481 may include multiple pieces of material that are attached to each other.

In some embodiments, the fastener 448 is configured to couple both the retention component 481 and the interlock component 409 to the upper portion 414. In other words, a single fastener may couple both the retention component 481 and the interlock component 409 to the mounting rail 102.

In some embodiments, the mounting rail 402 may include the bias element 132 shown in FIG. 1. In some embodiments, the deformable clip 408 may be positioned proximate to longitudinal ends of the upper portion 414. In other embodiments, the deformable clip 408 may be positioned proximate to a center of the length of the upper portion 414.

The mounting rail 402 is illustrated as including four retention features 110 and the interlock components 409 are illustrated as including four deformable clips 408 for example purposes. The mounting rail 402 may include any number of retention features 110, if not omitted, such as one, two, three, or more retention features 110. In addition, the interlock components 409 may include any appropriate number of deformable clips 408 such as one, two, three, or more deformable clips 408.

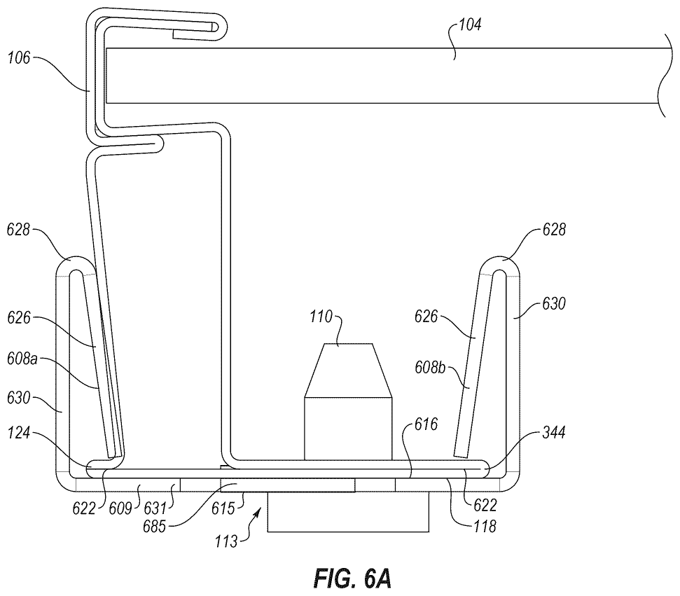

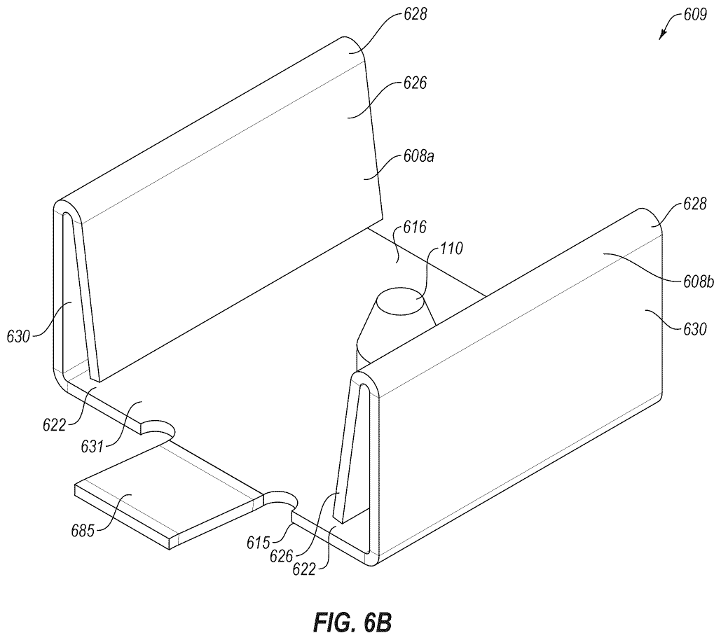

FIGS. 6A and 6B illustrate an additional embodiment of an example interlock component 609 that includes deformable clips 608a-b to couple the interlock component 609 to the PV module 104. FIG. 6A illustrates a side view of the interlock component 609 coupled to the module frame 106. FIG. 6B illustrates a perspective view of the interlock component 609. The interlock component 609 may be configured to interface with a mounting rail to couple the module frame 106 to the mounting rail. For example, the interlock component 609 may be implemented with the mounting rail 402 of FIGS. 4A-5.

The interlock component 609 may include the deformable clips 608a-b, which may operate the same as or similar to the deformable clips 108, 308a-c, or 408 describe above. The deformable clip 608b may interface with the edge of the return flange 344 (e.g., a second lip) instead of the lip 124. The interlock component 609 may include both of the deformable clips 608a-b to enhance the interlock of the module frame 106 and the interlock component 609.

The interlock component 609 may include a connection member 631 that includes a surface 615 that engages with the surface of the upper portion of the mounting rail. In addition, the connection member 631 may include a surface 616 that engages with the bottom surface 118 of the module frame 106. Further, the deformable clips 608a-b may be connected the connection member 631. The deformable clips 608a-b may include attachment portions 630 that are connected between the connection member 631 and joints 628. In addition, the deformable clips 608a-b may include angled portions 626 that are connected to the joints 628 and extend towards the connection member 631. The deformable clips 608a-b and the connection member 631 may define apertures 622 that are configured to receive the lip 124 or the edge of the return flange 344 of the module frame 106. In some embodiments, the interlock component 609 may include a unitary piece of material.

The deformable clip 608a may operate the same as or similar to the deformable clips 108, 308a-b, or 408 described above in relation to the lip 124. In addition, the deformable clip 608b may operate the same as or similar to the secondary deformable clip 308c described above in relation to the edge of the return flange 344. In some embodiments, the deformable clips 608a-b may be elastically deformable such that during installation of the PV module 104, the deformable clips 608a-b move to a deformed configuration to permit the lip 124 and the edge of the return flange 344 to be received in the apertures 622.

During installation, the module frame 106 may be positioned such that the edge of the return flange 344 and the lip 124 are proximate to the angled portions 626. The module frame 106 may be moved toward the angled portions 626 to cause the lip 124 to interface with the angled portion 626 of the deformable clip 608a, the edge of the return flange 344 to interface with the angled portion 326 of the deformable clip 608b, or both. The module frame 106 may continue to be moved to cause the joints 628 to selectively deform (e.g., elastically deform). The deformable clips 608a-b may selectively deform and move to transition from first positions (e.g., equilibrium positions or locked configurations as shown in FIGS. 6A and 6B) to second positions (e.g., deformed configurations). In the second position, the lip 124 and the edge of the return flange 344 may move along surfaces of the angled portions 626 and be received in and be at least partially disposed in the apertures 622. In other words, the lip 124 and the edge of the return flange 344 engaging with the angled portions 626 may cause the angled portions 626 to move out of the way of the lip 124 and the edge of the return flange 344 and permit the lip 124 and the edge of the return flange 344 to be received in the apertures 622.

When the lip 124 and the edge of the return flange 344 are disposed within the apertures 622, the deformable clips 608a-b may return to the first position such that a portion of the lip 124 and the edge of the return flange 344 are positioned between the deformable clips 608a-b and the connection member 631 to interlock the module frame 106 and the interlock component 609. Alternatively, when the lip 124 and the edge of the return flange 344 are disposed within the apertures 622, the deformable clip 608a-b may transition to a third position (e.g., a partially returned positioned) that is between the second position and the first position such that the lip 124 and the edge of the return flange 344 are positioned between the deformable clips 608a-b and the connection member 631 to interlock the module frame 106 and the interlock component 609. In addition, when the lip 124 and the edge of the return flange 344 are received in the apertures 622, the deformable clips 608a-b moving from the second position to the first position or to the third position may cause the deformable clips 608a-b to make sounds (e.g., audible clicks), which may indicate that the lip 124 and the edge of the return flange 344 are disposed within the apertures 622 and at least partially coupled to the interlock component 609. Additionally or alternatively, the deformable clips 608a-b moving from the second position to the first position or to the third position may cause the deformable clips 608a-b to create physical feedback (e.g., haptic feedback) via the module frame 106, which may indicate that the lip 124 and the edge of the return flange 344 are disposed within the apertures 622 and at least partially coupled to the interlock component 609. In other words, the deformable clips 608a-b moving from the second position to the first position or to the third position may create a sound or physical feedback to indicate that the lip 124 and the edge of the return flange 344 are in the apertures 622. For example, the deformable clips 608a-b moving from the second position to the first position or to the third position may cause the module frame 106 to vibrate, which an installer may detect and use to determine that the module frame 106 is installed (e.g., the lip 124 and the edge of the return flange 344 are disposed within the apertures 622 and at least partially coupled to the interlock component 609).

In some embodiments, the interlock component 609 may include or be coupled to the mounting rail via the retention feature 110. In other embodiments, the retention feature 110 may be omitted. As shown in FIGS. 6A and 6B, the interlock component 609 includes a lifting spring 685. Alternatively, the lifting spring 685 may be omitted.

The lifting spring 685 may extend from the connection member 631 such that at least a portion of the lifting spring 685 is positioned above the surface 616 of the connection member 631. The lifting spring 685 may apply a biasing force on the module frame 106 when the lip 124 and the edge of the return flange 344 are at least partially disposed in the apertures 622. The lifting spring 685 may apply the biasing force in a direction that is generally perpendicular to the surface 616 of the connection member 631. The lifting spring 685 may apply the biasing force to urge the lip 124 and the edge of the return flange 344 against the deformable clips 608a-b to enhance the interlock of the module frame 106 with the interlock component 609.

The lifting spring 685 may apply the biasing force to prevent the lip 124 and the edge of the return flange 344 from moving within the apertures 622. Additionally or alternatively, the lifting spring 685 may apply the biasing force to prevent the module frame 106 from rattling against the interlock component 609 (e.g., against the connection member 631 or the deformable clips 608a-b). The lifting spring 685 shown in FIGS. 6A and 6B is a flexible spring. However, alternative embodiments for the lifting spring 685 may include a spring, a flange, a louver, a flexible pad, a rubber pad, or any other appropriate device.

In some embodiments, the interlock component 609 may be positioned proximate to longitudinal ends of the mounting rail. In other embodiments, the interlock component 609 may be positioned proximate to a center of a length of the mounting rail.

In some embodiments, the deformable clips 608a-b may prevent movement of the module frame 106 along a width of the interlock component 609 (e.g., leftward, rightward, or both in FIG. 6A). The deformable clips 608a-b may prevent movement of the module frame 106 to prevent the lip 124, the edge of the return flange 344, or both from unintentionally exiting the apertures 622 and the module frame 106 from unintentionally uncoupling from the interlock component 609.

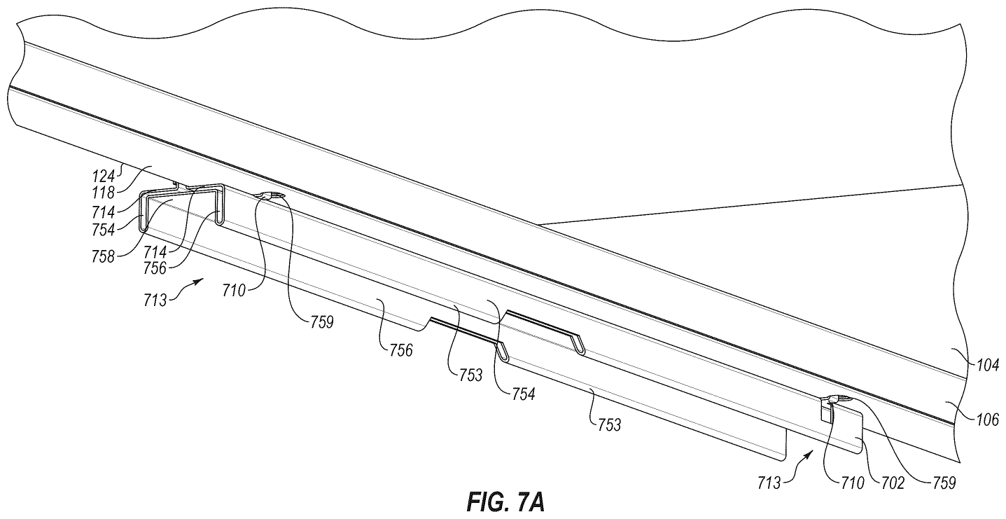

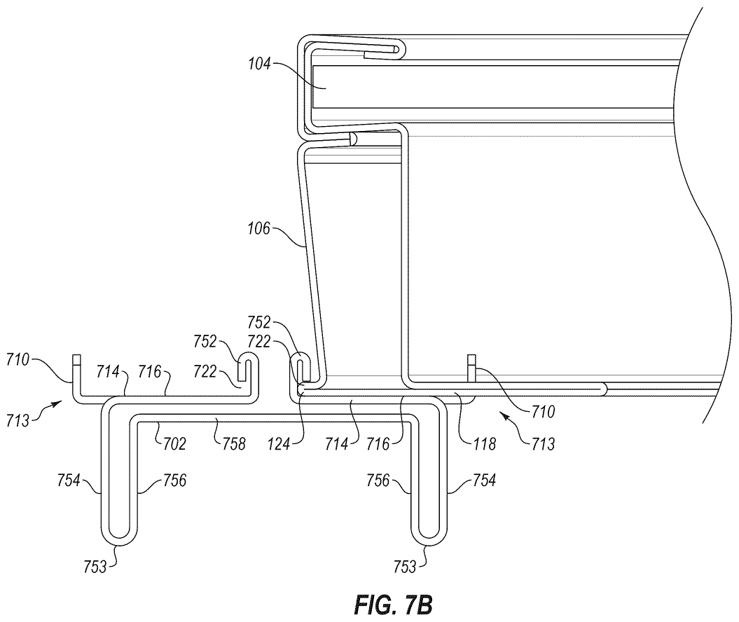

Referring to FIGS. 7A and 7B, an example of one mounting rail 702 coupled to the PV module 104 is shown. FIG. 7A illustrates a bottom perspective view of the example mounting rail 702 coupled to the PV module 104. FIG. 7B illustrates a side view of the example mounting rail 702 coupled to the PV module with a sidewall of the module frame 106 transparent.

The mounting rail 702, as discussed in more detail below, may couple to the PV module 104 via one or more rigid clips 752 (generally referred to in the present disclosure as the rigid clip 752), one or more location components 713 (generally referred to in the present disclosure as the location component 713) of the mounting rail 702, or some combination thereof. The rigid clip 752, the location component 713, or both may interface with the module frame 106 to couple the PV module 104 to the mounting rail 702. The location component 713 may engage with the module frame 106 to position the PV module 104 relative to the mounting rail 702, prevent movement of the module frame 106 relative to the mounting rail 702, or both. As shown, the mounting rail 702 is coupled to a single instance of the PV module 104. However, the mounting rail 702 may couple to multiple instances of the PV module 104. The mounting rail 702 may couple the PV module 104 to a torque tube (not shown in FIG. 7) or any other appropriate solar component to position the PV module 104 within a solar installation.

The mounting rail 702 may include upper portions 714 (generally referred to in the present disclosure as the upper portion 714) that are connected to external sidewalls 754. The rigid clip 752 may be connected to the upper portion 714 such that the rigid clip 752 and the upper portion 714 at least partially define an aperture 722. The aperture 722 may be configured to receive and at least partially dispose the lip 124 to interlock the module frame 106 with the mounting rail 702. In addition, the mounting rail 702 may include internal sidewalls 756 that are connected to the external sidewalls 754 via joints 753. Further, the mounting rail 702 may include a connection member 758 connected between the internal sidewalls 756. The upper portion 714 may include a surface 716 that physically engages with the bottom surface 118 of the module frame 106 to position the PV module 104 relative to the mounting rail 702.

The lip 124 may interface with the rigid clip 752 during installation of the PV module 104 to cause the joints 753 to selectively deform to compensate for differences between a width of the PV module 104 and a distance between the mounting rail 702 and a neighboring mounting rail (not shown in FIGS. 7A and 7B). In addition, the lip 124 may interface with the rigid clip 752 during installation of the PV module 104 to permit the surface 716 of the upper portion 714 to engage with the bottom surface 118 of the module frame 106 at different positions. Further, the lip 124 may interface with the rigid clip 752 to adjust a position of the upper portion 714 and the rigid clip 752 relative to the connection member 758 of the mounting rail 702.

During installation, the PV module 104 may be positioned such that the lip 124 is at least partially disposed within the aperture 722. The PV module 104 may be moved toward the rigid clip 752 (e.g., a leftward direction in FIG. 7B) to cause the lip 124 to interface with the rigid clip 752 and cause the joint 753 to selectively deform (e.g., elastically deform). The joint 753 may selectively deform and move to transition from a first position (e.g., an equilibrium position or a locked configuration as shown in FIGS. 7A and 7B) to a second position (e.g., a deformed configuration). In the second position, a distance between the external sidewall 754 and the internal sidewall 756 may be reduced compared to the first position. Additionally or alternatively, in the second position, a distance between the upper portion 714 and the connection member 758 may be reduced compared to the first position.

When the lip 124 is disposed within the aperture 722, a portion of the lip 124 may be positioned between the rigid clip 752 and the upper portion 714 to interlock the module frame 106 and the mounting rail 702. For example, the rigid clip 752 and the upper portion 714 may sandwich part of the lip 124. The portion of the lip 124 positioned between the rigid clip 752 and the upper portion 714 may couple the module frame 106 to the mounting rail 702. The lip 124 being at least partially disposed within the aperture 722 may prevent the module frame 106 from moving away from the surface 716 of the upper portion 714 (e.g., an upward direction in FIG. 7B). For example, the rigid clip 752 may engage with a surface of the lip 124 to maintain the engagement between the upper portion 714 and the bottom surface 118.

In some embodiments, the location component 713 may include one or more retention features 710 (generally referred to in the present disclosure as the retention feature 710) connected to the upper portion 714. In other embodiments, the retention feature 710 may be omitted. The retention feature 710 may interface with the module frame 106 to prevent movement of the PV module 104 along a width of the upper portion 714 (e.g., a leftward direction, a rightward direction, or both in FIG. 7B), a length of the upper portion 714 (e.g., into or out of the page of FIG. 7B), or both. For example, as shown in FIG. 7A, the retention feature 710 interfaces with an opening 759 defined by the module frame 106 to prevent the module frame 106 from moving away from the rigid clip 752 (e.g., the rightward direction in FIG. 7B).

The retention feature 710 may prevent movement of the PV module 104 along the width of the upper portion 714 to prevent the lip 124 from unintentionally exiting the aperture 722. For example, when installed, the PV module 104 may experience a load (e.g., wind, snow, or other factors that apply a force on the PV module 104), which may try and cause the lip 124 to exit the aperture 722 and the retention feature 710 may prevent this from occurring. The retention feature 710 may extend from the surface 716 of the upper portion 714 at a generally perpendicular angle. In the example shown, the retention feature 710 includes a tab that is connected to the upper portion 714. However, alternative embodiments of the retention feature 110 may be implemented. Example alternative embodiments of the retention feature 110 are discussed below in relation to FIGS. 13A-13M.

During installation, the PV module 104 may be positioned such that the openings 759 defined by the module frame 106 are aligned with the retention feature 710. The PV module 104 may be moved toward the upper portion 714 to cause the openings 759 defined by the module frame 106 to receive the retention feature 710. In some embodiments the retention feature 710 may include a spring-loaded tab and operate similar to retention feature 810 described below.

In some embodiments, the rigid clip 752 may prevent movement of the PV module 104 along a width of the upper portion 714 (e.g., in a leftward direction in FIG. 7B). The mounting rail 702 may include the bias element 132. Alternatively, the bias element 132 may be omitted.

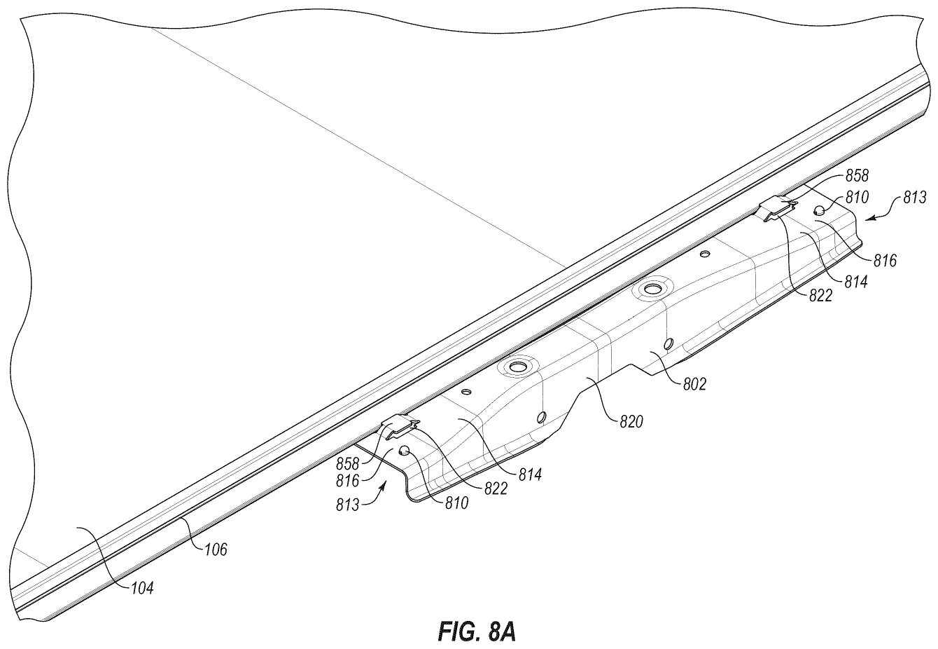

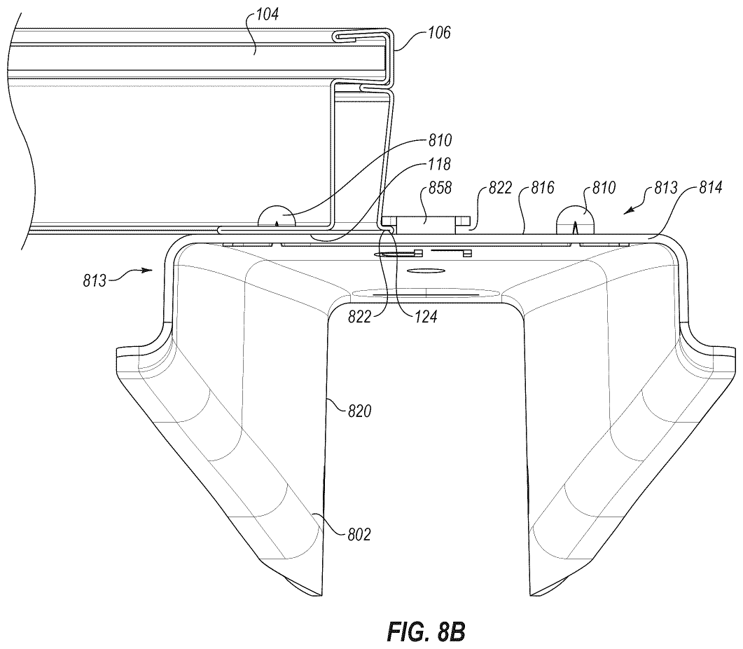

Referring to FIGS. 8A and 8B, an example of one mounting rail 802 coupled to the PV module 104 is shown. FIG. 8A illustrates a perspective view of the example mounting rail 802 coupled to the PV module 104. FIG. 8B illustrates a side view of the example mounting rail 802 coupled to the PV module 104 with a sidewall of the module frame 106 hidden.

The mounting rail 802, as discussed in more detail below, may couple to the PV module 104 via one or more rigid clips 858 (generally referred to in the present disclosure as the rigid clip 858), one or more location components 813 (generally referred to in the present disclosure as the location component 813) of the mounting rail 802, or some combination thereof. In some embodiments, the mounting rail 802 may be coupled to the PV module 104 using a slide in technique in which the PV module 104 is positioned relative to the mounting rail 802 and then slid along a length of the mounting rail 802 to cause one or more components of the mounting rail 802 to interface with the module frame 106. In some embodiments, the mounting rail 802 may be coupled to the PV module 104 using a slide in technique in which the PV module 104 is positioned proximate to the rigid clip 858 and then slid along a width of the mounting rail 802 to cause one or more components of the mounting rail 802 to interface with the module frame 106.

The rigid clip 858, the location component 813, or both may interface with the module frame 106 to couple the PV module 104 to the mounting rail 802. In particular, the rigid clip 858 may interface with the lip 124 of the module frame 106 during installation, operation, or both. The location component 813 may interface with the module frame 106 to position the PV module 104 relative to the mounting rail 802, prevent movement of the module frame 106 relative to the mounting rail 802, or both. As shown, the mounting rail 802 is coupled to a single instance of the PV module 104. However, the mounting rail 802 may couple to multiple instances of the PV module 104. The mounting rail 802 may couple the PV module 104 to a torque tube (not shown in FIGS. 8A and 8B) or any other appropriate solar component to position the PV module 104 within a solar installation.

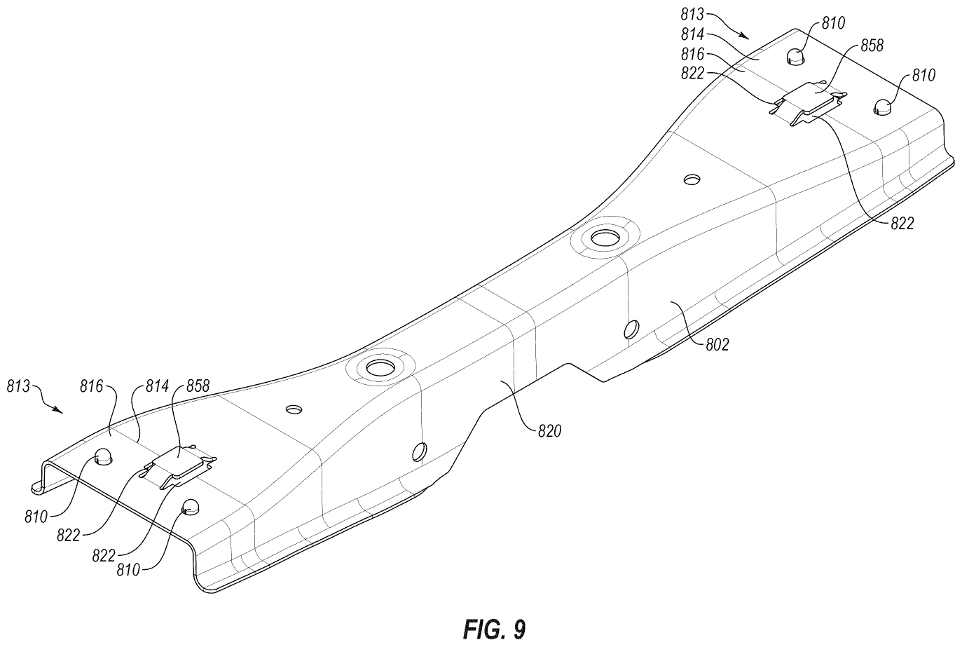

With combined reference to FIGS. 8A-9, the mounting rail 802 may include upper portions 814 (generally referred to in the present disclosure as the upper portion 814). In some embodiments, the upper portion 814 may be connected to a connection portion 820. The connection portion 820 may be configured to interface with a torque tube (not shown in FIGS. 8A-9) or other solar component. The upper portion 814 may include a surface 816 that physically engages with the bottom surface 118 of the module frame 106 to position the PV module 104 relative to the mounting rail 802.

The rigid clip 858 may be connected to the upper portion 814 such that the rigid clip 858 and the upper portion 814 at least partially define an aperture 822. The aperture 822 may be configured to receive and at least partially dispose the lip 124 to interlock the module frame 106 with the mounting rail 802. In some embodiments, the rigid clip 858 may include a general inability to be bent or otherwise deform to maintain the coupling of the module frame 106 and the mounting rail 802. In some embodiments, the rigid clip 858 may include a stronger material, a thicker material, a shorter height, or some combination thereof compared to the deformable clips 108, 308a-c, 408, or 608a-b discussed above.

In some embodiments, the location component 813 may include one or more retention features 810 (generally referred in the present disclosure as the retention feature 810). In other embodiments, the retention feature 810 may be omitted. The retention feature 810 may facilitate a position of the PV module 104 relative to the mounting rail 802. In addition, the retention feature 810 may interface with the module frame 106 to prevent movement of the PV module 104 along the width of the upper portion 814 (e.g., leftward, rightward, or both in FIG. 8B), a length of the upper portion 814 (e.g., into or out of the page of FIG. 8B), or both. For example, the retention feature 810 may interface with the openings defined by the module frame 106 to prevent movement of the module frame 106.

The retention feature 810 may be coupled to the upper portion 814. In addition, the retention feature 810 may be coupled to the upper portion 814 such that at least a portion of the retention feature 810 extends beyond the upper portion 814. The retention feature 810 may prevent the lip 124 from unintentionally exiting the aperture 822 (e.g., due to the load on the PV module 104 or other action). The retention feature 810, as discussed in more detail below, during installation, may engage with the module frame 106 to cause the retention feature 810 to move and permit the module frame 106 to move along a length or a width of the mounting rail 802. In the example shown, the retention feature 810 includes a spring-loaded stud coupled to the upper portion 814. However, alternative embodiments of the retention feature 810 may be implemented. Example alternative embodiments of the retention feature 810 are discussed below in relation to FIGS. 13A-13M.

During installation, the PV module 104 may be positioned such that an end of the lip 124 is proximate to the aperture 822. The PV module 104 may be moved along the length or the width of the mounting rail 802 to cause the lip 124 to be received in the aperture 822. In addition, the PV module 104 may be moved to cause the lip 124 to move (e.g., slide) between the rigid clip 858 and the upper portion 814. Further, the PV module 104 may be moved to cause an end of module frame 106, the bottom surface 118, or both to engage with the retention feature 810. The engaging of the module frame 106 with the retention feature 810 may cause the retention feature 810 to selectively move to transition from a first position. (e.g., an equilibrium position or a locked configuration as shown in FIGS. 8A-9) to a second position (e.g., a deformed position). In other words, the module frame 106 engaging with the retention feature 810 may cause the retention feature 810 to move out of the way of the module frame 106 and permit the module frame 106 to continue moving along the length or the width of the mounting rail 802. The bottom surface 118 engaging with the retention feature 810 may cause the retention feature 810 to remain in the second position.

When in the second position, the retention feature 810 may experience a spring force (e.g., a restoring force) urging the retention feature 810 back to the first position. However, the bottom surface 118, when engaged with the retention feature 810, may prevent the retention feature 810 from returning to the first position. The PV module 104 may be moved along the length or the width of the upper portion 814 until the retention feature 810 is aligned with the corresponding opening defined by the module frame 106. When the retention feature 810 is aligned with the corresponding opening, the spring force may cause the retention feature 810 to return to the first position and be received in the corresponding opening. In this manner, the retention feature 810 may permit the PV module 104 to be installed and interface with the module frame 106 to support and prevent movement of the module frame 106 relative to the mounting rail 802.

In some embodiments, the mounting rail 802 may include the bias elements 132. Alternatively, the bias element 132 may be omitted. The mounting rail 802 is illustrated as including four retention features 810 and two rigid clips 858 for example purposes. The mounting rail 802 may include any number of retention features 810, if not omitted, such as one, two, three, or more retention features 810. In addition, the mounting rail 802 may include any appropriate number of rigid clips 858 such as one, two, three, or more rigid clips 858.

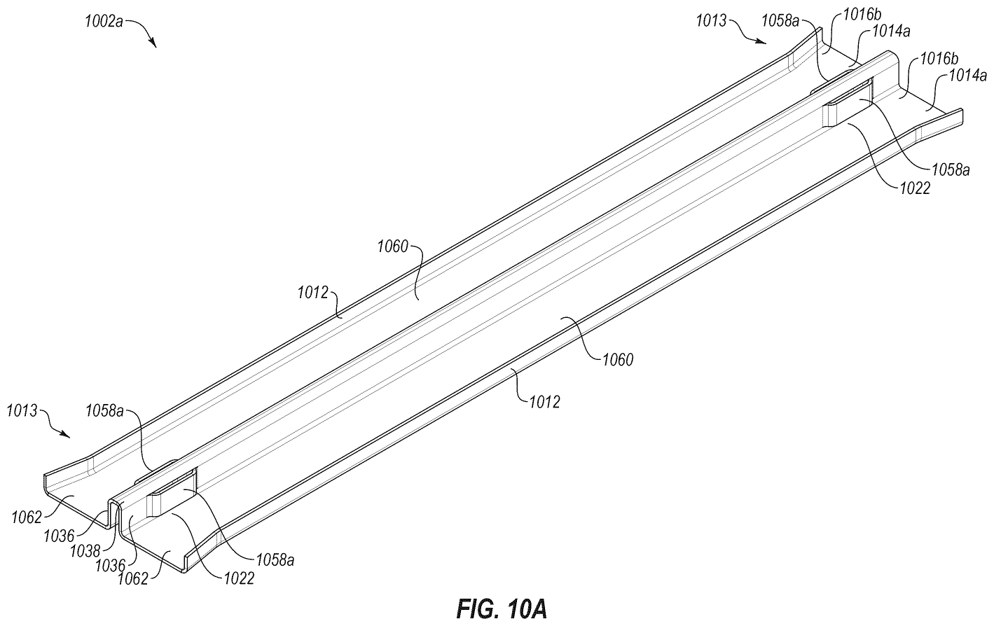

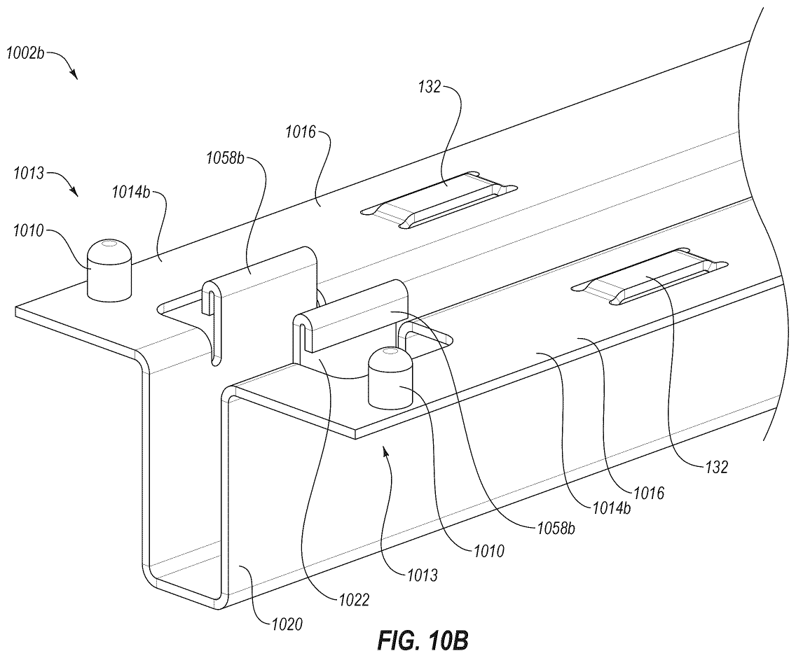

FIGS. 10A and 10B illustrate additional embodiments of example mounting rails 1002a-bthat include rigid clips 1058a-b. The mounting rails 1002a-b may operate the same as or similar to the mounting rail 802 of FIGS. 8A-9 to couple the module frame 106 to the corresponding mounting rail 1002a-b.

FIG. 10A illustrates a perspective view of the mounting rail 1002a. In the example shown in FIG. 10A, the mounting rail 1002a includes sidewalls 1036 that are connected to each other to form a joint 1038. In addition, the sidewalls 1036 extend along at least a portion of a length of the mounting rail 1002a. Further, the mounting rail 1002a includes rigid clips 1058a that extend from the sidewalls 1036. The rigid clips 1058a may operate the same as or similar to the rigid clips 752, 858, or both described above.

The mounting rail 1002a includes location components 1013. In the embodiment shown in FIG. 10A, the location components 1013 include extension elements 1012 connected to the upper portion 1014a. The extension elements 1012 may interface with the module frame 106 to prevent movement of the PV module 104 along a width of the upper portion 1014a. For example, the extension elements 1012 may interface with edges of the module frame 106 on opposite sides of the lip 124 to prevent the module frame 106 from moving away from the rigid clips 1058a.

The extension elements 1012 may prevent movement of the PV module 104 along the width of the upper portion 1014a to prevent the lip 124 from unintentionally exiting the apertures 1022. For example, when installed, the PV module 104 may experience a load (e.g., wind, snow, or other factors that apply a force on the PV module 104), which may try and cause the lip 124 to exit the apertures 1022 and the extension elements 1012 may prevent this from occurring. The extension elements 1012 may extend from the surfaces 1016 of the upper portions 1014a at a generally perpendicular angle. In the example shown, the extension elements 1012 include flanges that are connected to the upper portions 1014a and extend continuously along at least part of a length of the upper portions 1014a. In some embodiments, the extension elements 1012 may include instances of the rigid clips 1058a that extend from the extension elements 1012. In these and other embodiments, the rigid clips 1058a extending from the sidewalls 1036 may be omitted.

The sidewalls 1036 and the extension elements 1012 may define channels 1060 configured to receive the module frame 106 as the PV module 104 moves along a length of the mounting rail 1002a. The channels 1060 may be defined to include tapered openings 1062 to make alignment of an end of the module frame 106 with the channels 1060 easier.

In the example shown in FIG. 10A, the mounting rail 1002a includes a unitary piece of material. Alternatively, the mounting rail 1002a may include multiple pieces of material that are coupled together.

FIG. 10B illustrates a perspective view of a section of the mounting rail 1002b. In the example shown in FIG. 10B, the mounting rail 1002b includes upper portions 1014b that are connected to a connection portion 1020. The connection portion 1020 may be shaped and sized to interface with a torque tube interface (not shown in FIG. 10B) or other solar component. The upper portions 1014b may include surfaces 1016 that physically engage with the bottom surface 118 of the module frame 106 to position the PV module 104 relative to the mounting rail 1002b. Further, the mounting rail 1002b includes rigid clips 1058b that extend from the upper portions 1014b. The rigid clips 1058b may operate the same as or similar to the rigid clips 752, 858, or 1058a-b described above. As shown in FIG. 10B, the mounting rail 1002b includes retention features 1010 (generally referred to in the present disclosure as retention feature 1010). The retention feature 1010 may operate the same as or similar to the retention feature 810 described above.

In the example shown in FIG. 10B, the mounting rail 1002b includes a unitary piece of material. Alternatively, the mounting rail 1002b may include multiple pieces of material that are coupled together. In the example shown in FIG. 10B, the upper portions 1014b include the bias elements 132. Alternatively, the bias elements 132 may be omitted.

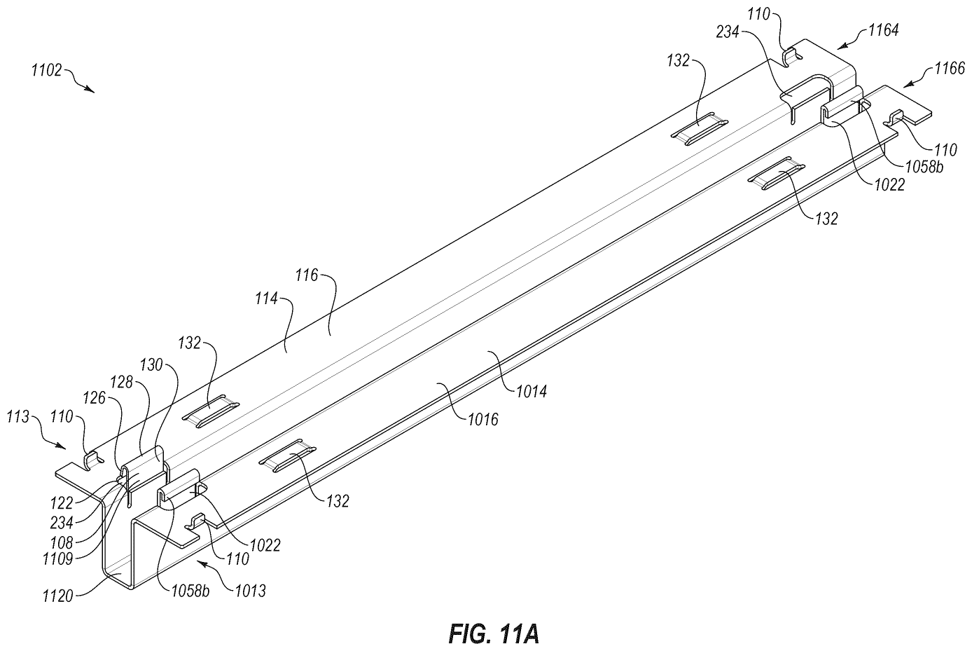

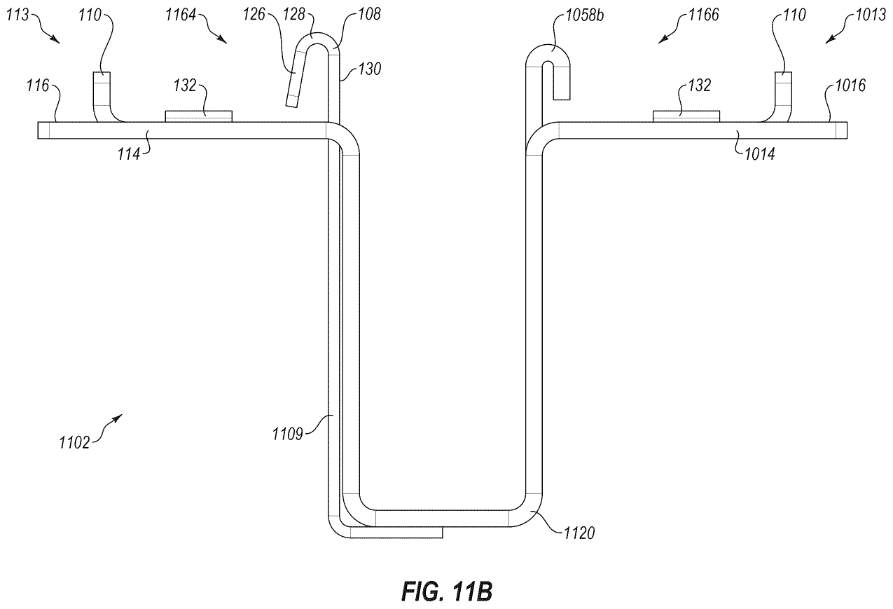

FIGS. 11A and 11B illustrate an example embodiment of a mounting rail 1102 that includes a deformable portion 1164 and a rigid portion 1166. The deformable portion 1164 may be connected to the rigid portion 1166 via a connection portion 1120. The mounting rail 1102 may include an asymmetric design that permits the module frame 106 to couple to the mounting rail 1102 using different techniques.

The deformable portion 1164 may operate the same as or similar to the mounting rail 102 described above but may include interlock components 1109 that interface with one side of the mounting rail 1102. Alternatively, the deformable clips 108 may be formed from the same piece of material as the upper portion 114 and the connection portion 1120. The deformable portion 1164 may permit the module frame 106 to be coupled to the deformable portion 1164 using the drop in technique discussed above.

The rigid portion 1166 may operate the same as or similar to the mounting rail 1002b described above. The rigid portion 1166 may permit the module frame 106 to be coupled to the rigid portion 1166 using the slide in technique discussed above.

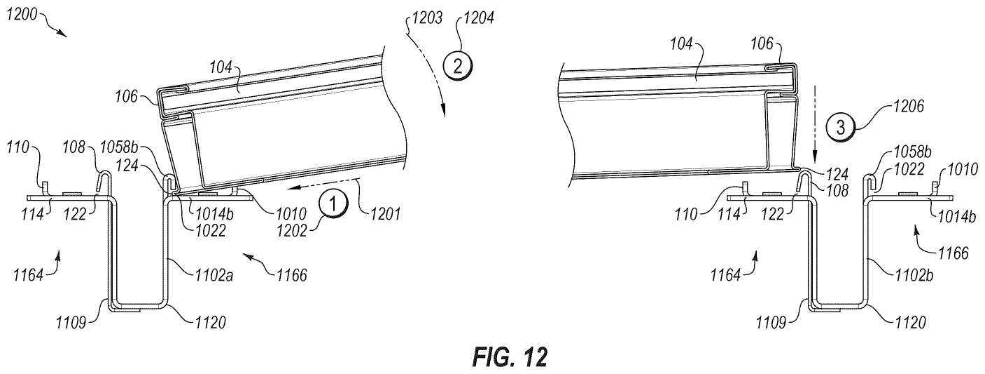

FIG. 12 illustrates an example process diagram 1200 to couple the PV module 104 to two instances of the mounting rail 1102a-b of FIGS. 11A and 11B. As a result of the process 1200, the PV module 104 may be coupled to the mounting rails 1102a-b to position the PV module 104 within a solar installation.

The process 1200 may include inserting 1202 the lip 124 into the aperture 1022 defined by the rigid clip 1058b and the upper portion 1014b of the rigid portion 1166 of the mounting rail 1102a. In some embodiments, the lip 124 may be inserted at an angle as the module frame 106 moves along a width of the upper portion 1014b. Arrow 1201 illustrates an example angle for inserting the lip 124 in the aperture 1022.

The process 1200 may include rotating 1204 the PV module 104 such that the module frame 106 approaches the deformable portion 1164 of the mounting rail 1102b. Arrow 1203 illustrates an example direction of the rotation of the PV module 104. The process 1200 may include inserting 1206 the lip 124 into the aperture 122 defined by the deformable clip 108 and the upper portion 114. In some embodiments, the inserting 1206 may include the lip 124 engaging with the deformable clip 108 to cause the deformable clip 108 to selectively deform as discussed above.

FIGS. 13A-13M illustrate example embodiments of example retention features 1310a-g that may be implemented with one or more of the mounting rails 102, 302a-e, 402, 702, 802, 1002a-b, or 1102, the interlock component 609, or both described in the present disclosure. The retention features 1310a-h may operate the same as or similar to the retention features 110, 810, or 1010 described in the present disclosure.

FIG. 13A illustrates a perspective view 1301a of a section of the mounting rail 102 including the retention feature 1310a as a bent tab formed from the same piece of material as the upper portion 114. Additional or alternative embodiments of the retention feature 1310a may include a tab, a pin, or a stud.

FIGS. 13B and 13C illustrate a perspective view 1301c and a perspective view 1301d of a section of an example module frame 1306b, respectively. The example module frame 1306b, as shown, includes a lip 1324a that defines a clip feature 1310c. The clip feature 1310c may operate as a retention feature, a location feature, an alignment feature, or some combination thereof as described in more detail below.

As shown, the module frame 1306b is formed such that the lip 1324a forms a multilayer structure that includes two layers. The lip 1324a may define a notch or other negative space in a single or upper layer of the multilayer structure and a part corresponding to an edge 1323 of the lip 1324a. The notch defined by the lip 1324a may form the clip feature 1310c. Additionally or alternatively, the other layer of the multilayer structure may form a bottom portion or bottom surface of the clip feature 1310c.

As shown, the clip feature 1310c is located such that a portion 1329 (referred to in the present disclosure as edge portion 1329) of the clip feature 1310c extends along the part corresponding to the edge 1323. In addition, as shown, the clip feature 1310c is located such that a portion 1331 (referred to in the present disclosure as upper portion 1331) of the clip feature 1310c extends along a portion of an upper section 1325 of the lip 1324a. The edge portion 1329 may extend along a first plane and the upper portion 1331 may extend along a second plane that is different than the first plane. In other words, the clip feature 1310c may extend along multiple planes, which may permit the clip feature 1310c to operate as a retention feature, a location feature, an alignment feature, or some combination thereof as described in more detail below.

During installation, the module frame 1306b may be positioned such that a deformable clip (e.g., deformable clip 108, 308a-b, 408, or 608a-b) physically contacts the edge 1323 of the lip 1324a. The module frame 1306b may be moved while at least partially maintaining contact between the deformable clip and the edge 1323 until the deformable clip is received in the clip feature 1310c. In other words, the module frame 1306b may be moved until a leading portion of the deformable clip contacts a sidewall 1327 of the clip feature 1310c and the deformable clip is received in the edge portion 1329. As such, the clip feature 1310c may operate as a location feature.

When the deformable clip is received in the edge portion 1329, the module frame 1306b may be aligned relative to the deformable clip and/or the corresponding mounting rail. As such, the clip feature 1310c may operate as a location feature or an alignment feature.

During installation and when the deformable clip is received in the edge portion 1329, the module frame 1306b may be pushed down to cause the deformable clip to selectively deform and move out of the way of the module frame 1306b as described in more detail elsewhere in the present disclosure but in relation to a portion of the lip 1324 corresponding to the clip feature 1310c. The module frame 1306b may be moved until the deformable clip clears the lip 1324 and the portion of the lip 1324 corresponding to the clip feature 1310c is received in and at least partially disposed in the corresponding aperture and the module frame 1306b is in an installed position. In the installed position, the deformable clip may be received in the upper portion 1331. When the deformable clip is received in the upper portion 1331, the sidewalls 1327 may prevent movement of the module frame 1306b along a length of the corresponding mounting rail. As such, the clip feature 1310c may operate as a retention feature.

The multilayer structure of the lip 1324a is illustrated as including two layers for example purpose. The multilayer structure of the lip 1324a may include more or fewer layers. For example, the multilayer structure may include three, four, or more layers. Only a single sidewall 1327 of the clip feature 1310c is numbered in FIGS. 13C, but the clip feature 1310c may include another sidewall located on an opposite end as the sidewall 1327 that is shown.

FIG. 13D illustrates a cross-sectional view 1301e of the mounting rail 302d including the retention feature 1310d as a wire form clip. FIG. 13E illustrates a perspective view 1301f of the mounting rail 302d including the retention feature 1310d as the wire clip. As shown in FIGS. 13D and 13E, the retention feature 1310d may interface with openings defined by the module frame 106 and a loop 1333 connected to the upper portion 114. A portion of the retention feature 1310d may extend through the upper portion 114 and the module frame 106 to prevent movement of the module frame 106 along the length of the mounting rail 102.

FIG. 13F illustrates a perspective view 1301g of an example return flange 1315 of a module frame that includes retention features 1310e adjacent an opening 1311. The opening 1311 may permit a fastener or other connection device to pass through the opening and draw the return flange 1315 towards an upper portion. The retention features 1310d may include ramp components 1388 that are sloped in different directions to prevent movement. Additionally or alternatively, the retention features 1310d may function to bias the return flange 1315 against other components (e.g., may operate the same as or similar to the bias element 132).

In some embodiments, the fastener may include a quarter turn fastener (not shown) with a head that is configured to engage the ramp components 1388. The head of the fastener may move along surfaces of the ramp components 1388 to draw the return flange 1315 towards the upper portion. In particular, as a thickness of the ramp components 1338 between the head of the fastener and the upper portion increases, the head of the fastener may apply an increasing the force to bias the return flange 1315 against the upper portion.

FIG. 13G illustrates a bottom perspective view 1301h of the mounting rail 1002b that includes the retention feature 1310f as a spring bolt. One end 1313 of the retention feature 1310f may be coupled or otherwise connected to the upper portion 1014b and an opposite end 1317 of the retention feature 1310f may not be coupled to the upper portion 1014b. In this manner, the module frame 106 engaging the retention feature 1310f may cause the end 1313 to selectively deform and the retention feature 1310f to move out of the way of the module frame 106 (e.g., move to a second position). When the retention feature 1310f interfaces with an opening of the module frame 106, the retention feature 1310e may return to a first position.

FIGS. 13H-13K illustrate a perspective view 1301i-l of an example mounting rail 1302 that includes the retention feature 1310g. As shown in FIGS. 13H-13K, the retention feature 1310g includes a tapered pin. FIG. 13I illustrates a perspective view 1301j of the example mounting rail 1302 coupled to an example module frame 1306c via the retention feature 1310g. FIGS. 13J and 13K illustrate side views 1301k and 1301l, respectively, of the module frame 1306c coupling to the mounting rail 1302. The mounting rail 1302 may be implemented with other components not illustrated in FIGS. 13H-13K. For example, the mounting rail 1302 may include the deformable clips 108 described above.

With combined reference to FIGS. 13H-13K, the module frame 1306c may include beams 1361 that extend across at least a portion of an opening 1363 defined by the module frame 1306c. The beams 1361 may engage with the retention feature 1310g to position the module frame 1306c relative to the mounting rail 1302. In some embodiments, the beams 1361 may engage with the retention feature 1310g to position the retention feature 1310g proximate to a center of the opening 1363.

During installation, the module frame 1306c may be positioned proximate to the retention feature 1310g or such that the beams 1361 contact an upper surface of the retention feature 1310g. As shown in FIG. 13J, the module frame 1306c may be moved to cause the retention feature 1310g to engage with the beams 1361 and cause the beams 1361 to selectively deform. The beams 1361 selectively deforming may permit the retention feature 1310g to pass through the opening 1363. As shown in FIG. 13K, when the retention feature 1310g has passed through the opening 1363 a particular distance, the beams 1361 may disengage with the top surface of the retention feature 1310g and return to a default position and the beams 1361 may be positioned between a portion of the retention feature 1310g and the mounting rail 1302.

FIG. 13L illustrates a perspective view 1301m of an example upper portion 1314 that includes a retention feature 1310h formed from the same piece of material. FIG. 13M illustrates a perspective view 130 In of the example upper portion 1314 interfacing with an example module frame 1306d. In FIG. 13M, the upper portion 1314 is hidden by the module frame 1306d except for a first raised portion 1365 and a second raised portion 1369 of the retention feature 1310g. The retention feature 1310h may include a spring-loaded tab that is configured to interface with openings defined by the module frame 1306d.

The retention feature 1310h may include the first raised portion 1365, a recessed portion 1367, and the second raised portion 1369. The first raised portion 1365 may be connected to the upper portion 1314. In addition, the recessed portion 1367 may be connected to and positioned between the first raised portion 1365 and the second raised portion 1369. The module frame 1306d during installation may engage with the retention feature 1310h to cause the retention feature 1310h to selectively deform (e.g., elastically deform) and move to transition from a first position (e.g., an equilibrium position or a locked configuration) as shown in FIG. 13D) to a second position (e.g., a deformed configuration).

In the second position, the retention feature 1310h may experience a spring force (e.g., a restoring force) urging the retention feature 1310h back to the first position. However, a bottom surface of the module frame 1306d, when engaged with the retention feature 1310h, may prevent the retention feature 1310h from returning to the first position. The module frame 1306d may be moved along the upper portion 1314 until the retention feature 1310h is aligned with the corresponding openings. In particular, when the first raised portion 1365 is aligned with a corresponding opening and the second raised portion 1369 is aligned with a corresponding opening. When the retention feature 1310h is aligned with the corresponding openings, the spring force may cause the retention feature 1310h to return to the first position and be received in the corresponding openings. In addition, the spring force may cause the retention feature 1310h to return to the first position and dispose a portion 1371 of the module frame 1306d between the first raised portion 1365 and the second raised portion 1369. In this manner, the retention feature 1310h may interface with the module frame 1306d to support and prevent movement of the module frame 1306d.

The retention features 110, 710, 810, 1010, or 1310a,c-h described in the present disclosure may include a tab, a stud, a pin, a wire form clip, a protrusion, or some combination thereof. Additional or alternatively, one or more instances of the retention features 110, 710, 810, 1010, or 1310a,c-h may include multiple tabs, studs, pins, or some combination thereof. For example, the retention features 710 or 1310a may include multiple tabs that are positioned proximate to each such that the multiple tabs are received in a single instance of the openings (e.g., opening 759) defined by the module frame 106.

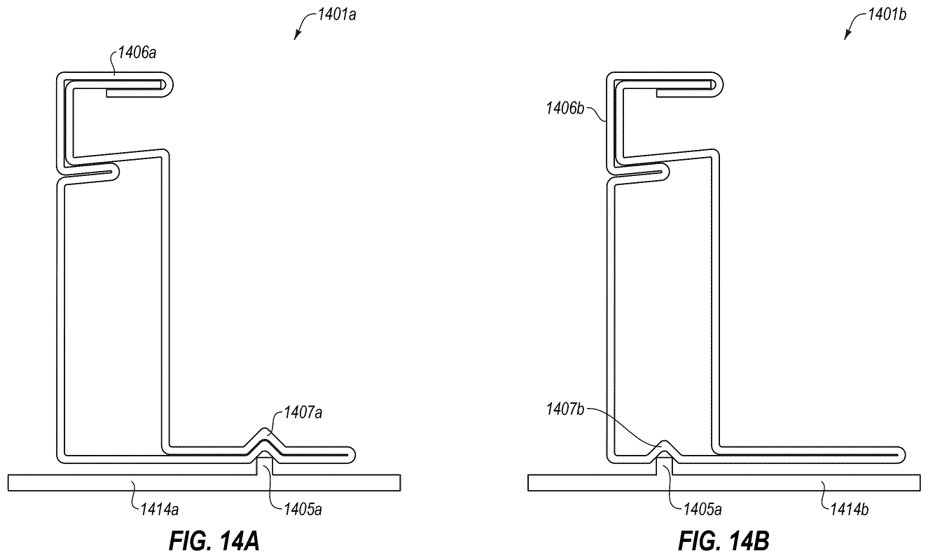

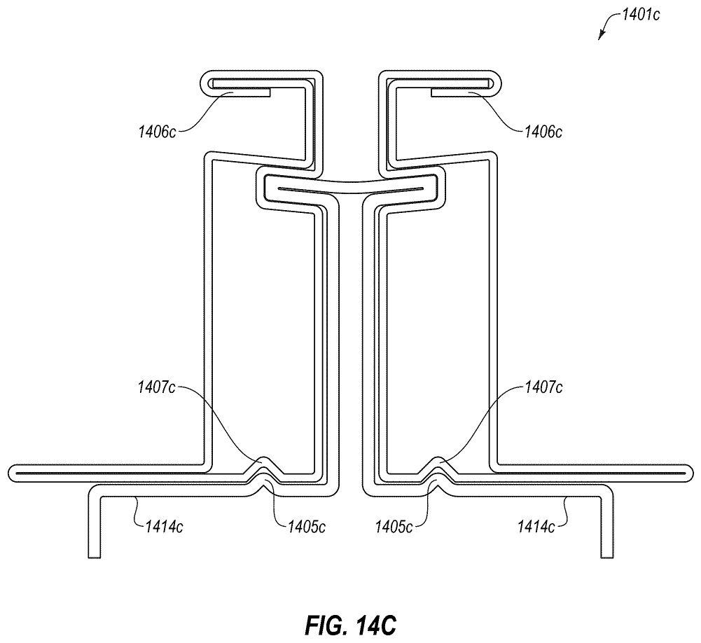

FIGS. 14A-14C illustrate side views 1401a-c of example embodiments of upper portions 1414a-c that include alignment protrusions 1405a-c and module frames 1406a-c that include alignment grooves 1407a-c. The example upper portions 1414a-c include alignment protrusions 1405a-cpositioned at different positions along a width of the example upper portions 1414a-c. The alignment protrusions 1405a-c may extend from surfaces of the upper portions 1414a to interface with the alignment grooves 1407a-c. The alignment protrusions 1405a-c may be positioned at different positions along the width to interface with the alignment grooves 1407a-c defined by the module frames 1306a-c at different positions. The alignment protrusions 1405a-c and alignment grooves 1407a-c may maintain an alignment of the module frames 1406a-c relative to the upper portions 1414a-c while the module frames 1406a-c are moving along a length of the mounting rails 1402a-c.

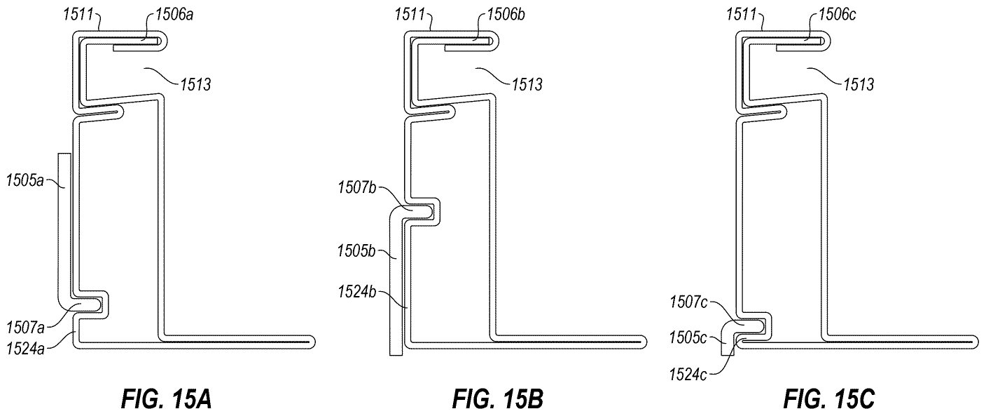

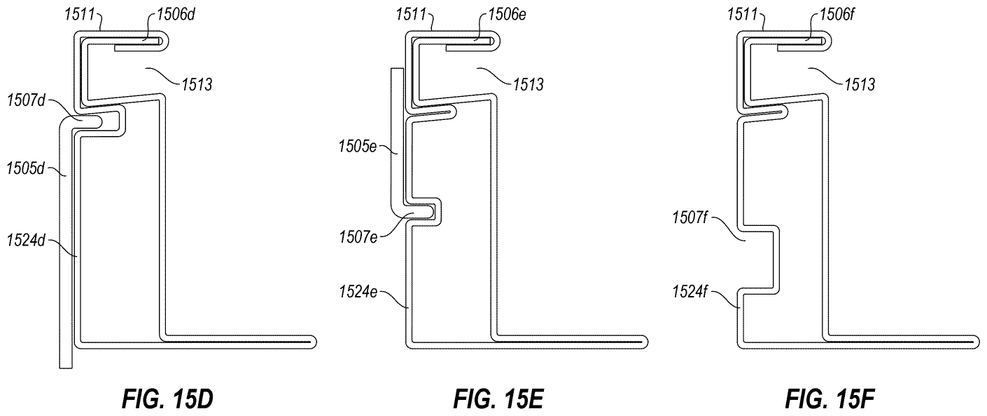

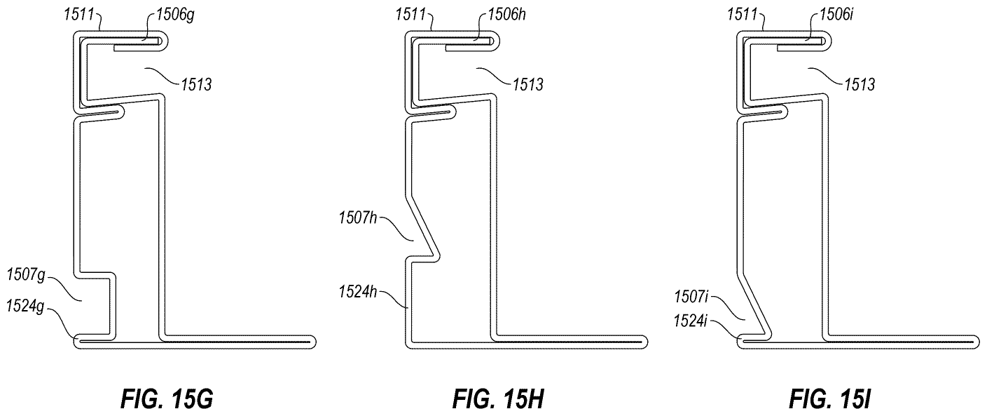

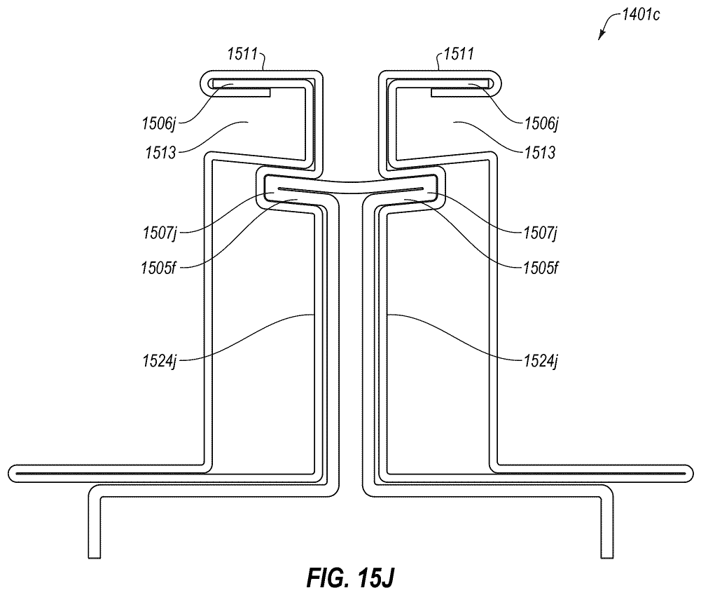

FIGS. 15A-15J illustrate additional embodiments of module frames 1506a-j that include lips 1524a-j of different heights to interface with clips 1505a-f at different heights. In addition, the module frames 1506a-j may define recesses 1507a-j of different shapes or sizes. For example, the module frames 1506a-e 1506j may define the recesses 1507a-e and 1507j as rectangles that are shorter than they are deep. As another example, the module frames 1506f and 1506g may define the recesses 1507f and 1507g as rectangles that are taller than they are deep. As yet another example, the module frames 1506h and 1506i may define the recesses 1507h and 1507i as triangles. The module frames 1506a-j may be implemented with one or more of the deformable clips 108, 308a-c, 408, or 608a-b, the rigid clips 752, 858, 1058a-b, or some combination thereof.

As shown in FIGS. 15A-15J, the module frames 1506a-j may include panel portions 1511 that define panel openings 1513. The panel openings 1513 may be configured to receive a PV panel (not shown). In some embodiments, the recesses 1507a-i may be defined such that at least a portion of the panel portions 1511 overlap the recesses 1507a-i. Additionally or alternatively, the recesses 1507a-i and the panel openings 1513 may be defined such that the panel openings 1513 at least partially overlap the recesses 1507a-i.

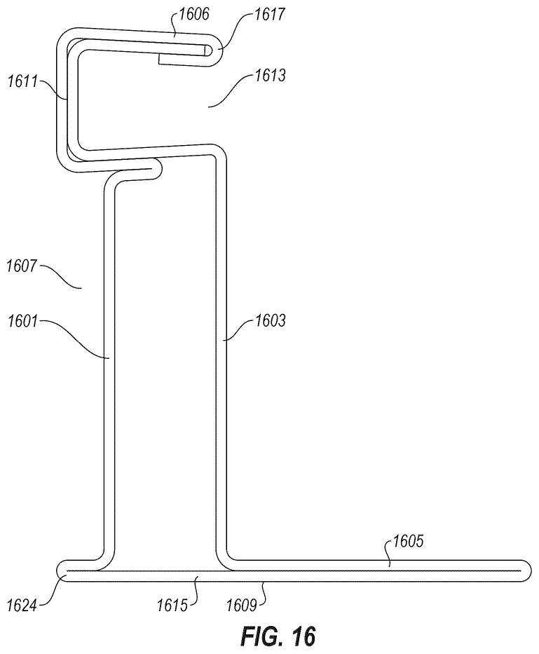

FIG. 16 illustrates an additional embodiment of a module frame 1606 that includes a lip 1624 configured to interface with the various deformable clips 108, 308a-c, 408, or 608a-b or the various rigid clips 752, 858, or 1058a-b described in the present disclosure. The module frame 1606 may include a sidewall 1601 that is connected to the lip 1624. The sidewall 1601 may extend from the lip 1624 to a panel portion 1611. The lip 1624 may extend from the sidewall 1601 so as to be received in and at least partially disposed in the apertures 122, 322a-b, 342,422, 622, 722, 822, or 1022 described in the present disclosure.

The module frame 1606 may include a sidewall 1603 that extends from the return flange 1605 to the panel portion 1611. The return flange 1605 may extend from the sidewall 1603. The module frame 1606 may also include a bottom portion 1615 that is connected to and forms at least part of the return flange 1605 or the lip 1624. The bottom portion 1615 may include a bottom surface 1609 that is configured to physically engage with the various upper portions 114, 414, 714, 814, 1014a-b, or 1314 described in the present disclosure.

The panel portion 1611 may connect the sidewalls 1601 and 1603 to each other. In addition, the bottom portion 1615, the return flange 1605, and the lip 1624 may connect the sidewalls 1601 and 1603 to each other. Further, the panel portion 1611 may define a panel opening 1613 that is configured to receive a PV panel.

As shown in FIG. 16, the sidewall 1601, the lip 1624 and the panel portion 1611 define a recess 1607. The recess 1607 may be defined such that at least a portion of the panel portion 1611 overlaps the recess 1607. Additionally or alternatively, the recess 1607 and the panel opening 1613 may be defined such that the panel opening 1613 at least partially overlap the recesses 1607.

In some embodiments, the module frame 1606 may be formed using a unitary piece of material that is bent, folded, or otherwise manipulated to form the module frame 1606. In other embodiments, the module frame 1606 may be formed using multiple pieces of material. The module frame 1606 may be formed such that at least part of the panel portion 1611 forms a multilayer structure. In some embodiments, the panel portion 1611 may be formed such that a hooked portion 1617 defines an opening that receives an end of the unitary piece of material. In some embodiments, the module frame 1606 may be formed of a steel material. As shown, ends of the unitary piece of material may be located proximate to or form part of the hooked portion 1617 such that the hooked portion 1617 forms the multilayer structure including three layers.

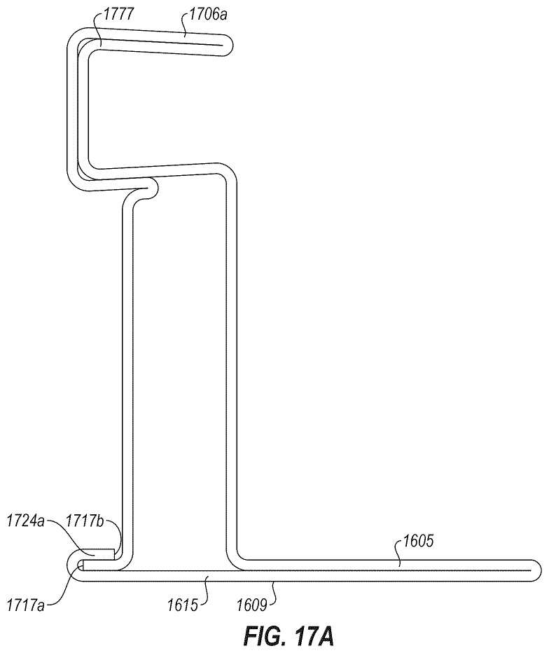

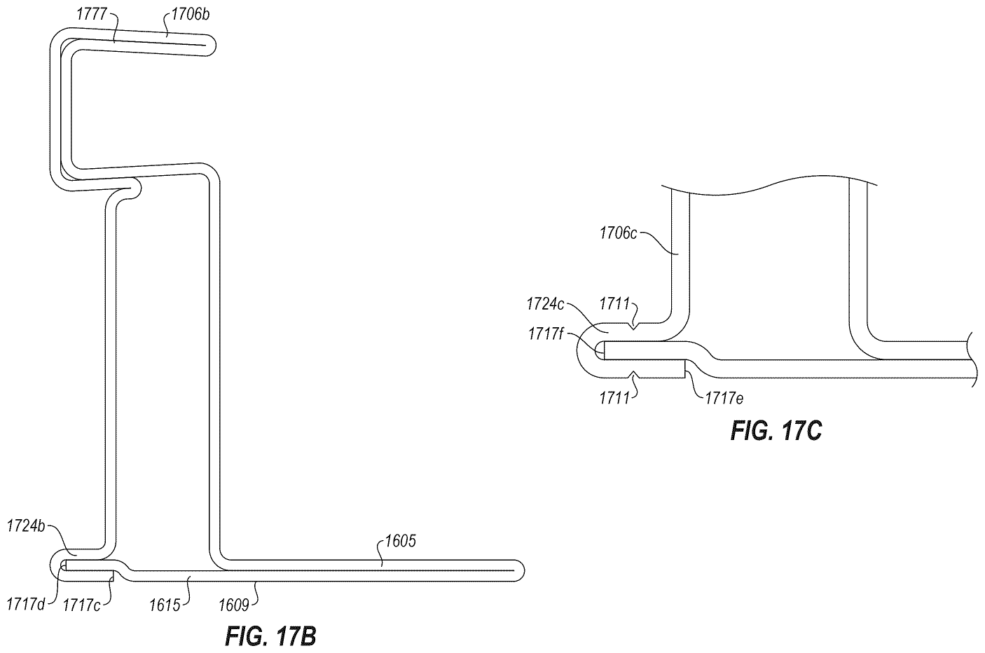

FIGS. 17A-17C illustrate embodiments of module frames 1706a-c that include lips 1724a-c configured to interface with the various deformable clips 108, 308a-c, 408, 608a-b or the various rigid clips 752, 858, or 1058a-b described in the present disclosure. FIG. 17A illustrates a side view of the example module frame 1706a. FIG. 17B illustrates a side view of the example module frame 1706b. FIG. 17C illustrates a side view of a section of the example module frame 1706c. The example module frames 1706a-c may be similar to the module frame 1606 of FIG. 16 except that the module frames 1706a-c include unitary pieces of material that are formed such that the lips 1724a-c include multilayer structures.

With reference to FIG. 17A, in some embodiments, the module frame 1706a may be formed using a unitary piece of material that is bent, folded, or otherwise manipulated such that ends 1717a-b of the unitary piece of material form at least part of the lip 1724a. As shown in FIG. 17A, the module frame 1706a is formed such that an end 1717a of the unitary piece of material is positioned within an opening formed by the unitary piece of material. In addition, as shown in FIG. 17A, the module frame 1706a is formed such that another end 1717b of the unitary piece of material is positioned proximate to and/or forms an upper portion of the lip 1724a.

With reference to FIG. 17B, in some embodiments, the module frame 1706b may be formed using a unitary piece of material that is bent, folded, or otherwise manipulated such that ends 1717c-d of the unitary piece of material form at least part of the lip 1724b. As shown in FIG. 17B, the module frame 1706b is formed such that an end 1717d of the unitary piece of material is positioned within an opening formed by the unitary piece of material. In addition, as shown in FIG. 17B, the module frame 1706b is formed such that another end 1717c of the unitary piece of material is positioned proximate to and/or forms a lower portion of the lip 1724b.

With reference to FIG. 17C, the module frame 1706c may be formed using a unitary piece of material that is bent, folded, or otherwise manipulated such that ends 1717e-f of the unitary piece of material form at least part of the lip 1724c. As shown in FIG. 17C, the module frame 1706c is formed such that an end 1717f of the unitary piece of material is positioned within an opening formed by the unitary piece of material. In addition, as shown in FIG. 17C, the module frame 1706c is formed such that another end 1717e of the unitary piece of material is positioned proximate to and/or forms a lower portion of the lip 1724c. Further, the lip 1724c may be pressed or otherwise manipulated such that grooves 1711 are formed on the lower portion, an upper portion, or both of the lip 1724c. The grooves 1711 may increase an engagement between the upper portion, the lower portion, or both and the end of the unitary piece of material that is positioned within the opening formed by the unitary piece of material.

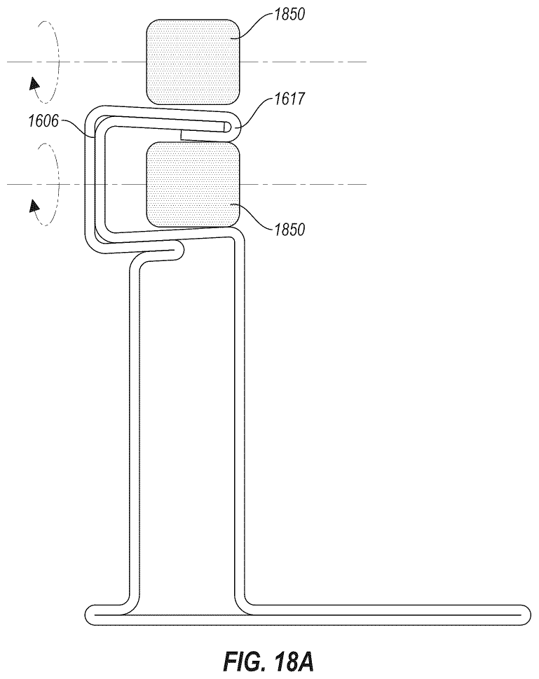

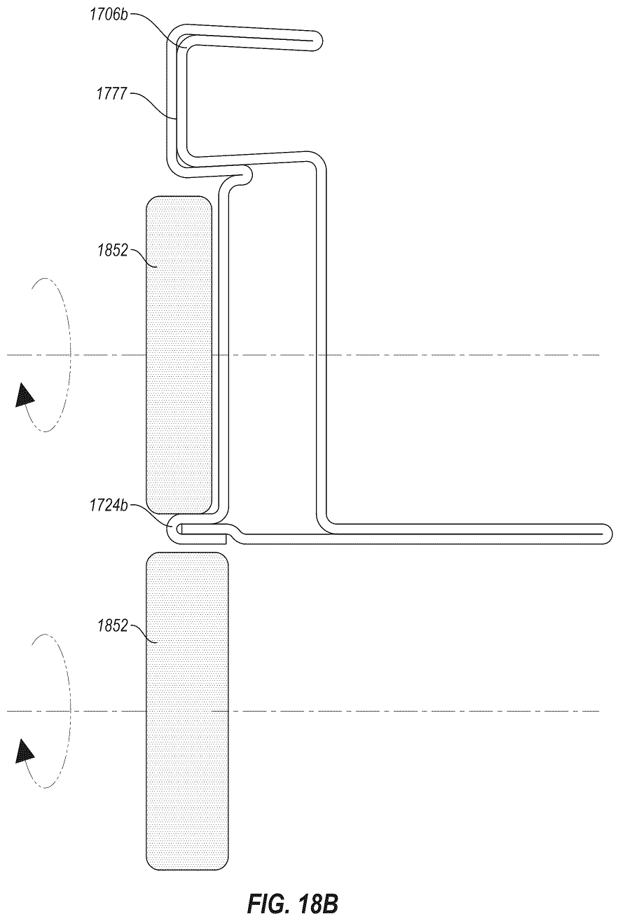

FIG. 18A illustrates an example embodiment of a process to form the module frame 1606 of FIG. 16. FIG. 18B illustrates an example embodiment of a process to form the module frame 1706b of FIG. 17B. With reference FIG. 18A, the multilayer structure of the hooked portion 1617 may be pressed by rollers 1850 to close the multilayer structure. A size of the rollers 1850 used to press the multilayer structure may be based on a size of the panel opening 1613.

With reference to FIGS. 17 and 18B, the multilayer structure of the lip 1724b may be pressed by rollers 1852 to close the multilayer structure. A size of the rollers 1852 that may be used to press the multilayer structure may be based on a distance between the lip 1724b and a panel portion 1777 of the module frame 1706b.

As shown in FIGS. 18A and 18B, the rollers 1850 to form the module frame 1606 are smaller than the rollers 1852 to form the module frame 1706b because the rollers 1850 are limited to a size that will fit within the panel opening 1613. The increased size of the rollers 1852 may permit additional pressure to be applied to the multilayer structure of the lip 1724b compared to pressure applied to the multilayer structure of the hooked portion 1617 by the rollers 1850. The additional pressure applied by the rollers 1852 may result in a tighter seam in the lip 1724b compared to the seam in the hooked portion 1617. The tighter seam in the lip 1724b may increase a resistance to prevent the different layers of the lip 1724b from moving relative to each other compared to the seam in the hooked portion 1617. The increased resistance to prevent the different layers from moving relative to each other may increase a torsional rigidity of the module frame 1706b compared to the module frame 1606.

The module frame 1706b of FIG. 17B is illustrated for example purposes. The process to form the module frame 1706b may also be used to form the module frame 1706a of FIG. 17A. Additionally or alternatively, the process to form the module frame 1706b may also be used to form the module frame 1706c except that the rollers 1852 may include shaped rollers to form the grooves 1711 on the lower portion, an upper portion, or both.

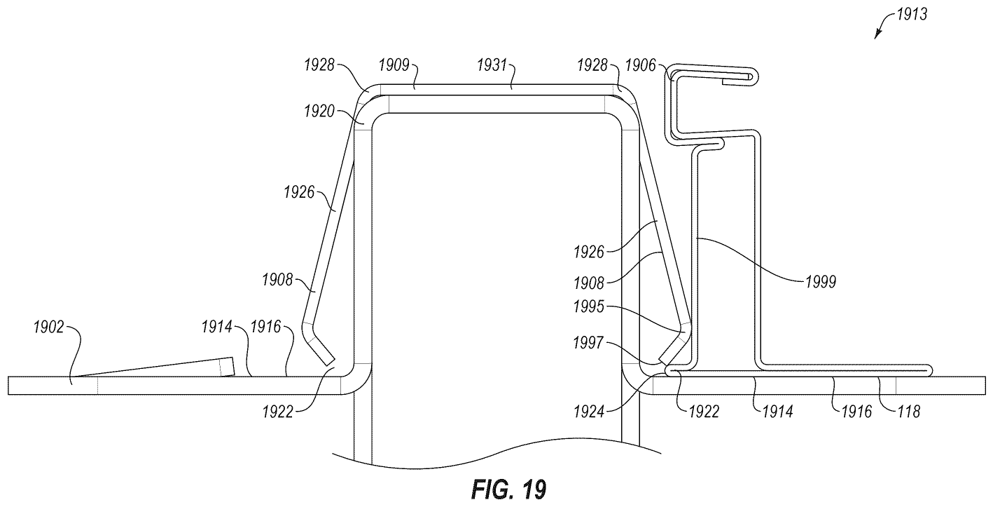

Referring to FIG. 19, an example of one mounting rail 1902 coupled to an example module frame 1906 is shown. The mounting rail 1902 may couple to the module frame 1906 via one or more interlock components 1909 (generally referred to in the present disclosure as the interlock component 1909), one or more location components 1913 (generally referred to in the present disclosure as the location component 1913), or some combination thereof.

The interlock component 1909 may include a deformable clip 1908 that interfaces with the module frame 106 to couple the PV module 104 to the mounting rail 402. As shown in FIG. 19, the deformable clip 1908 may engage with both a sidewall 1999 and a lip 1924 of the module frame 1906. In some embodiments, the deformable clip 1908 may engage with both the sidewall 1911 and the lip 1924 of the module frame 1906 to distribute a load applied by the deformable clip 1908 between the sidewall 1999 and the lip 1924 of the module frame 1906.

The mounting rail 1902 may operate the same as or similar to the mounting rails 102, 302a-e, 402, 702, 802, 1002a-b, or 1102 described above. In addition, the interlock component 1909 may operate the same as or similar to the interlock components 109, 409, and 609 described above.

The mounting rail 1902 may include upper portions 1914 (generally referred to in the present disclosure as the upper portion 1914). In some embodiments, the upper portion 1914 may be connected to a connection portion 1920. The connection portion 1920 may be shaped and sized to interface with a torque tube (not shown in FIG. 19) or other solar component. The upper portion 1914 may include a surface 1916 that physically engages with the bottom surface 118 of the module frame 1906.

The interlock component 1909 may include a connection member 1931 that is connected to the deformable clips 1908. The deformable clips 1908 may be connected on opposite sides of the connection member 1931.

The deformable clip 1908 may selectively deform to permit the lip 1924 to enter one or more apertures 1922 (generally referred to in the present disclosure as the aperture 1922) at least partially defined by the deformable clip 1908 and the upper portion 1914. The deformable clip 1908 may include an angled portion 1926 connected to a joint 1928. The deformable clip 1908 may be coupled to the connection member 1931 to connect neighboring deformable clips 1908 to each other. The joint 1928 may include a radius of curvature such that the angled portion 1926 extends from the joint 1928 towards the upper portion 1914 when coupled to the module frame 1906. The angled portion 1926 may interface with the lip 124 during installation of the module frame 1906 as described above in relation to the deformable clips 108, 308a-c, 408, or 608a-b to cause the deformable clip 1908 to selectively deform.

When the lip 1924 is disposed within the aperture 1922, an end 1997 of the deformable clip 1908 may engage with the lip 1924. Additionally or alternatively, a joint 1995 of the deformable clip 1908 may engage with the sidewall 1999. Both the end 1997 and the joint 1995 may engage with the module frame 1906 to enhance the interlock of the module frame 1906 with the mounting rail 1902. Additionally or alternatively, the end 1997 and the joint 1995 may engage with the module frame 1906 to distribute a load between the two contact points.

What is claimed is:

1. A mounting rail system configured to couple to a photovoltaic (PV) module, the mounting rail system comprising:
a mounting rail including an upper portion comprising a surface configured to physically engage with a bottom surface of a module frame of the PV module; and
an interlock component engaged with the mounting rail, the interlock component comprising a clip, the clip and the upper portion of the mounting rail at least partially defining an aperture configured to receive a lip of the module frame during installation of the PV module to interlock the module frame with the mounting rail;
wherein the interlock component comprises a separate piece of material from the mounting rail

2. The mounting rail system of claim 1, wherein:
the upper portion defines an opening; and
the interlock component of the separate piece of material is configured to be received in the opening such that at least a portion of the interlock component extends from the opening.

3. The mounting rail system of claim 1, wherein the clip of the interlock component of the separate piece of material is configured to engage with both a sidewall of the module frame and the lip

4. The mounting rail system of claim 1, wherein the clip of the interlock component of the separate piece of material comprises a deformable clip configured to interface with the lip of the module frame during installation of the PV module to cause the deformable clip to selectively deform and permit the lip to be received in the aperture.

5. The mounting rail system of claim 4, wherein:
the deformable clip of the interlock component of the separate piece of material is configured to at least partially return to an equilibrium position when the lip is at least partially disposed in the aperture.

6. The mounting rail system of claim 1, wherein the clip of the interlock component of the separate piece of material is rigid and configured to prevent the bottom surface of the module frame from unintentionally disengaging with the upper portion.

7. The mounting rail system of claim 6, wherein the mounting rail comprises a first sidewall that extends along at least a portion of a length of the upper portion and a second sidewall that extends along at least a portion of the length of the upper portion, wherein the first sidewall and the second sidewall define a channel comprising a tapered opening configured to receive an end of the module frame to permit at least a portion of the module frame to move along a length of the mounting rail within the channel.

8. The mounting rail system of claim 1 wherein the interlock component of the separate piece of material comprises:
a connection member including a surface configured to physically engage with the surface of the upper portion; and
the clip connected to the connection member.

9. A mounting rail system configured to couple to a photovoltaic (PV) module, the mounting rail system comprising:
a mounting rail comprising an upper portion comprising a surface; and
an interlock component comprising a separate piece of material from the mounting rail, the interlock component configured to connect to the surface of the upper portion, the interlock component comprising:
a connection member comprising a surface configured to physically engage with a bottom surface of a module frame of the PV module; and
a deformable clip connected to the connection member, the deformable clip being configured to interface with a lip of the module frame during installation of the PV module to cause the deformable clip to selectively deform and permit the lip to be received in an aperture to interlock the module frame with the interlock component, the aperture being defined at least partially by the deformable clip and the surface of the connection member.

10. The mounting rail system of claim 9, wherein, the deformable clip comprises a first deformable clip, the lip comprises a first lip, the aperture comprises a first aperture, and the interlock component comprises:
a second deformable clip connected to the connection member, the second deformable clip being configured to interface with a second lip of the module frame during installation of the PV module to cause the second deformable clip to selectively deform and permit the second lip to be received in a second aperture to interlock the module frame with the interlock component, the second aperture being defined at least partially by the second deformable clip and the surface of the connection member.

11. The mounting rail system of claim 9, wherein the interlock component comprises a lifting spring connected to the connection member, the lifting spring being configured to apply a biasing force on the module frame to urge the lip against the deformable clip to enhance the interlock of the module frame with the interlock component.

12. The mounting rail system of claim 9 comprising a retention feature:
extending from the connection member, the retention feature being configured to interface with the module frame to prevent movement of the PV module relative to the interlock component to prevent the lip from unintentionally exiting the aperture; and
configured to couple the interlock component to the surface of the upper portion.

13. A mounting rail configured to couple to a photovoltaic (PV) module, the mounting rail comprising:
an upper portion configured to physically engage with a bottom surface of a module frame of the PV module;
a clip, the clip and the upper portion at least partially defining an aperture configured to receive a lip of the module frame during installation of the PV module to interlock the module frame with the mounting rail; and
a retention feature positioned along a width of the upper portion and extending from the upper portion, wherein the retention feature comprises a tapered pin connected to the upper portion, the retention feature comprising the tapered pin being configured to interface with an opening defined by the module frame to prevent movement of the PV module along the width of the upper portion to prevent the lip from unintentionally exiting the aperture.

14. The mounting rail of claim 13 comprising a lifting spring configured to apply a biasing force on the module frame to urge the lip against the clip to enhance the interlock of the module frame with the mounting rail.

15. The mounting rail of claim 13, comprising a retention component including:
the retention feature; and
a lifting spring connected to the retention feature, the lifting spring configured to apply a biasing force on the module frame to urge the lip of the module frame against the clip to enhance the interlock of the module frame with the mounting rail.

16. The mounting rail of claim 13, wherein the tapered pin is configured to:
engage with beams of the module frame to cause the beams to selectively deform and permit the retention feature to be received in an opening defined by the module frame; and
engage with the beams of the module frame when the retention feature is received in the opening, to prevent movement of the module frame relative to the mounting rail to prevent the lip from unintentionally exiting the aperture.

17. The mounting rail of claim 13, wherein the retention feature is formed from a same piece of material as the upper portion, the retention feature comprising:
a first raised portion connected to the upper portion, the first raised portion configured to be received in a first opening defined by the module frame;
a recessed portion connected to the first raised portion; and
a second raised portion connected to the recessed portion, the second raised portion configured to be received in a second opening defined by the module frame, wherein the retention feature is configured to dispose a portion of the module frame between the first raised portion and the second raised portion to prevent movement of the module frame relative to the mounting rail.

18. A mounting rail configured to couple to a photovoltaic (PV) module, the mounting rail comprising:
an upper portion comprising a surface configured to physically engage with a bottom surface of a module frame of the PV module; and
an alignment protrusion extending from the surface of the upper portion, the alignment protrusion configured to interface with an alignment groove defined by the module frame to align the module frame relative to the upper portion.

19. A mounting rail configured to couple to a photovoltaic (PV) module, the mounting rail comprising:
an upper portion comprising a surface configured to physically engage with a bottom surface of a module frame of the PV module;
a clip connected to the upper portion such that the clip and the upper portion define an aperture configured to receive a lip of the module frame to interlock the module frame with the mounting rail;
an external sidewall connected to the upper portion;
an internal sidewall; and
a joint connected to the external sidewall and to the internal sidewall, the joint configured to selectively deform to adjust a distance between the external sidewall and the internal sidewall to adjust a position of the upper portion and the clip to permit the upper portion to physically engage with the bottom surface of the module frame at different positions.

20. The mounting rail of claim 19 comprising a retention feature extending from the upper portion, the retention feature being configured to interface with the module frame during installation of the PV module to cause the retention feature to selectively deform and permit the retention feature to be received in an opening defined by the module frame to prevent movement of the PV module along a width of the upper portion and to prevent the lip from unintentionally exiting the aperture.
